(19) United States
(12) Patent Application Publication
(10) Pub. No.: US 2016/0275157 A1
(43) Pub. Date: Sep. 22, 2016

(54) Method and System for Analysing, Storing, and Regenerating Information

(71) Applicant: Genicap Beheer B.V., Tilburg (NL)

(72) Inventors: Johan Leo Alfons Gielis, Antwerpen (BE); Alexander Hermanns, Tilburg (NL)

(21) Appl. No.: 15/037,180

(22) PCT Filed: Nov. 17, 2014
(86) PCT No.: PCT/NL2014/050790

§ 371 Date: May 17, 2016

(30) Foreign Application Priority Data
Nov. 18, 2013 (NL) 2011811

(51) Int. Cl. G06F 17/30; G06F 17/11

(52) U.S. Cl. CPC G06F 17/30569; G06F 17/11

(57) ABSTRACT

The invention relates to a method for analysing information and for storing a representation related to the information in a computer memory. The invention also relates to a method for comparing information by using said method according to the invention. The invention then relates to a system for analysing information and storing a representation related to the information in a computer

The invention relates to a method for analysing information and for storing a representation related to the information in a computer memory. The invention also relates to a method for comparing information by using said method according to the invention. The invention moreover relates to a method for regenerating information which is stored as a representation after applying the aforementioned method according to the invention. The invention then relates to a system for analysing information and storing a representation related to the information in a computer memory, in particular by using said method according to the invention.

The role of information is becoming increasingly important in our society. Systems which store, transport and protect information have been introduced at all levels within society. Digital and analogue information, recorded in signals or symbols. From telephone calls to television and from books to the Internet. Information theory forms the basis of these developments. Only in the last 20 years has it been possible to translate this theory into practice due to the major advances in information technology. The emergence of increasingly fast and powerful computers has ensured that the ideas of the founders of information theory also become visible in daily life. Without them, things like the Internet, mobile telephony and office automation had been inconceivable. Attempts are made using various compression techniques to reduce the volume of the digital information without substantially compromising the completeness and quality of the information, so that the information requires less bandwidth during digital transfer and/or so that more information can be stored in a computer memory, such as a hard disk. Although the compression techniques result in some reduction in the volume of the digital information, this volume is relatively limited and the need exists to compress the information further without seriously compromising the quality and completeness of the information.

One object of the invention is to provide a method for compressing and storing information in an improved manner.

For this purpose, the invention provides a method of the type mentioned in the preamble, comprising the following steps: A) providing information in digital format to be analysed, B) converting the digital information into at least one set of coordinates relating to at least one preselected coordinate system, C) programming a computer with at least one first formula:

$$ρ ( ϑ ; f ( ϑ ) , A , B , {m}_{1 , 2 } , {n}_{1} , {n}_{2} , {n}_{3} ) = f ( ϑ ) [ \vert \frac{1}{A} cos \frac{{m}_{1} ϑ}{4} \vert \text{?} + / - \vert \frac{1}{B} sin \frac{{m}_{2} ϑ}{4} \vert \text{?} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by the parameters A, B, m₁, m₂, n₁, n₂, and/or n₃, and wherein a second set of parameters is formed by [symbol] and k.
   and wherein the computer is preferably also programmed with a second formula:

$$P ( ϑ ) = \text{?} {ρ}_{i} ( ϑ ; {f}_{j} ( ϑ ) , {A}_{j} , {B}_{j} , {m}_{1 j , 2 j} , {n}_{1 j} , {n}_{2 j} , {n}_{3 j} )$$

$$\text{?} \text{indicates text missing or illegible when filed}$$

which second formula is a summation of a plurality of first formulae; D) analysing, on the basis of the at least one set of coordinates, the digital information in the computer in order to determine at least one generalised comparison for the information, wherein the values for the first set of parameters, and preferably also the values for the second set of parameters, are determined; and E) storing in at least one computer memory, preferably a digital database, at least one cross-reference between information relating to at least one preselected coordinated system used during step B), and the first set of parameters and/or second set of parameters determined during step D).

The method according to the invention makes use of so-called Gielis curves and provides for the conversion of information via one or more sets of coordinates of one or more preselected coordinate systems, wherein, possibly via an n-dimensional graphical representation of the set(s) of coordinates, parameter values can be determined and are stored in a computer memory. The graphical representation does not therefore necessarily have to be produced here in order to arrive at the parameters. It is thus possible for the digital information to be converted directly into parameters. A graphical representation of the set(s) of coordinates and/or associated with the at least one set of parameters can possibly be displayed here to a user, which makes the transformation process clearer for a user. This makes it possible for large volumes of information to be converted into relatively complex graphical representations which can be expressed relatively simply, by means of some parameter values, and are stored, whereby, depending on the volume of the information, a significant reduction in the volume of the information can be achieved, which requires not only less capacity from the computer memory, but also less bandwidth in a digital transfer of the created alternative representation of the information. The preselection of the coordinate system(s) to be used during step B) can be carried out prior step B) or during step B). The preselection of the coordinate system(s) can be carried out by a computer, wherein the computer either creates at least one, preferably unique or random, coordinate system and/or selects at least one coordinate system from a set of predefined coordinate systems. The set of predefined coordinate systems can be created either automatically by a computer and/or manually. The preselection of the coordinate system(s) can—eventually additionally—be carried out manually, in particular by a user. In this latter case, a user or group of users either creates at least one, preferably unique or random, customized coordinate system and/or selects at least one coordinate system from a set of predefined coordinate systems. This preselection of coordinate systems to be used allows an infinite number of coordinate systems to be used when applying the method according to the invention, tremendously increases the flexibility to transform information into an alternative representation, and which moreover allows information to be transformed in a unique or non-conventional manner. The coordinate system preselected used during step B) and the set(s) of parameters found during step D) form a matching couple to be able to regenerate or recover the original information after transformation. Moreover, this facilitates calculation within the preselected coordinate system(s), for example in order to optimize shapes, if desired. Without the presence of information relating to the coordinate system(s) used during step B), the set(s) of parameters cannot be (re)converted to the original coordinate set, and hence not to the original information used prior to transformation. The preselected coordinate system could include at least one linear axis, at least one curved axis, at least one alternative axis, and combinations thereof. The information relating to the at least one preselected coordinate system as stored during step E) should preferably be sufficient in order to reconstruct (rebuild) the coordinate system used during step B). It is conceivable that the information relating to the at least one preselected coordinate system is stored in at least one first computer memory, while the at least one set of parameters is stored in another computer memory (second computer memory). The first computer memory and the second computer memory could form part of the same computer, though could also form part of different computers wherein both computer memories are physically separated.

By means of said formulae, derived from the Lamé formula in a polar system and also referred to as superformula(e), it is possible to synthesise practically all conceivable types of information, in particular forms (patterns), by varying said parameters. This makes it possible to synthesise a pattern for information, expressed in the form of one or more sets of coordinates, by means of modulations of parameters, said pattern substantially corresponding in terms of shape to the sets of coordinates or at least a projection thereof in a geometric space, as described in detail below. By then not storing the pattern as a compressed or uncompressed raster image, but only the related set(s) of parameters in a data collection, the volume of data that is stored in the data collection can thus be drastically reduced without compromising the quality of the information to which the set of parameters relates. The first formula is derived from the superformula and is further developed in the patent specification WO2004/111885, the content of which is deemed to form part of this patent specification through reference thereto. The second formula forms a summation of a plurality of transformations according to the first formula, whereby more complex graphical representations can be created. In a polar function, a three-dimensional shape can then also be defined as:

$${ρ}_{d} ( ϕ , ϑ ) = \frac{1}{\text{?} \sqrt{{\vert \frac{1}{c} cos \frac{{m}_{1}}{4} ϕ \vert}^{{l}_{2}} + / - {\vert \frac{1}{d} sin \frac{{m}_{2}}{4} ϕ \vert}^{{l}_{3}}}}$$

$$wherein \text{:}$$

$$c = \frac{1}{\text{?} \sqrt{\vert \frac{1}{a} cos \frac{{m}_{3}}{4} ϑ \vert \text{?} + / - \vert \frac{1}{b} sin \frac{{m}_{4}}{4} ϑ \vert \text{?}}}$$

$$\text{?} \text{indicates text missing or illegible when filed}$$

and wherein:
a, b, c, d>0; a, b, c, d, l₁, l₂, l₃, m₁, m₂, m₃, m₄, n₁, n₂, n₃)∈ [symbol] and n₁, l₁≠0
0≦ [symbol] ≦2kπ, wherein k∈ [symbol] , and
−½π≦φ≦½π.

The aforementioned polar function can be rewritten as follows in spherical coordinates:

$${ρ}_{d} ( ϑ , ϕ ) = {( {\vert \frac{sin \frac{p ϑ}{2} cos \frac{q ϕ}{4}}{{γ}_{1}} \vert}^{{v}_{1}} + {\vert \frac{sin \frac{p ϑ}{2} sin \frac{q ϕ}{4}}{{γ}_{2}} \vert}^{{v}_{2}} + {\vert \frac{cos \frac{p ϑ}{2}}{{γ}_{3}} \vert}^{{v}_{2}} )}^{- \frac{1}{{v}_{0}}}$$

wherein:
p and q relate to symmetry parameters;
γ₁, γ₂, γ₃ are analogous to said parameters a and b;
v₀, v₁, v₂, v₃ are analogous to n₀, nₓ, n_{y} (or n₀, n₁, n₂)
(p, q, v₁, v₂, v₃)∈ [symbol] ;
(γ₁, γ₂, γ₃, v₀)≧0;
0≦ [symbol] ≦kπ; where k∈ [symbol] , and
0≦φ≦2kπ, where k∈ [symbol] .

If the graphical representation relates to a closed shape and/or a more complex shape, the shape will usually be analysed by means of a modified Fourier analysis and by means of the R-function theory which both use said formula(e). An analysis of this type is known, wherein—as an example—reference is made to the following patent specifications, the content of which is deemed to form part of the present patent specification through reference thereto: U.S. Pat. No. 5,749,073 (System for automatically morphing audio information); U.S. Pat. No. 3,720,816 (Method for Fourier analysis of interference signals); U.S. Pat. No. 5,769,081 (Method for detecting cancerous tissue using optical spectroscopy and Fourier analysis); U.S. Pat. No. 5,425,373 (Apparatus and method for analyzing and enhancing intercardiac signals); U.S. Pat. No. 5,109,862 (Method and apparatus for spectral analysis of electrocardiographic signals); U.S. Pat. No. 5,657,126 (Ellipsometer); U.S. Pat. No. 5,416,588 (Small modulation ellipsometry); U.S. Pat. No. 5,054,072 (coding of acoustic waveforms); U.S. Pat. No. 4,885,790 (Processing of acoustic waveforms); and U.S. Pat. No. 4,937,868 (Speech analysis-synthesis system using sinusoidal waves). Reference is also made in this context to the patent specification EP 1177529 and the patent specification WO2011/161548, the content of which is also deemed to form part of the present patent specification.

For background information, reference is furthermore made to the following publications, the content of which is also deemed to form part of the present patent specification:
1. Gielis, J. A generic geometric transformation that unifies a large range of natural and abstract shapes. American Journal of Botany 90(3) Invited Special Paper, 333-338 (2003).
2. Bera, N., Bhattacharjee, J. K., Mitra, S. & Khastgir, S. P. Energy levels of a particle confined in a supercircular box. The European Physical Journal D 46, 41-50 (2008).
3. Richardson, J. S. et al. RNA Backbone: Consensus all-angle conformers and modular string nomenclature. RNA 14, 465-481 (2008).
4. Guitart, R. Les coordonnees curvilignes de Gabriel Lame, representations des situations physiques et nouveaux objects mathematiques. In: Gabriel Lame: Les peregrinations d'un ingenieur du XIXe siecle. Actes du Colloque. SABIX N° 44, 119-129 (2009).
5. Gielis, 1., Beirinckx, B. & Bastiaens, E. Superquadrics with rational and irrational symmetries. In: (Elber G. and Shapiro V., Eds). Proceedings of the 8th ACM Symposium on Solid Modeling and Applications, Seattle, Jun. 16-20, 2003, 262-265 (2003).
6. Ulrich, W. Decomposing the process of species accumulation into area dependent and time dependent parts. Ecological Research 21(4), 578-585 (2006).
7. Fougerolle, Y. D., Gribok, A., Foufou, S., Trucheret, F. & Abidi M. A. Boolean Operations with Implicit and Parametric Representation of Primitives Using R Functions. IEEE Transactions on Visualization and Computer Graphics 11(5), 529-539 (2005).
8. Johnson, J. E., Starkey, R. P. & Lewis, M.1. Aerodynamic stability of re entry heat shield shapes for a crew exploration vehicle. Journal of Spacecraft and Rockets 43 (4), 721-730 (2006).
9. Gielis, J., Haesen, S. & Verstraelen, L. Universal shapes: from the supereggs of Piet Hein to the cosmic egg of George Lemaitre. Kragujevac Journal of Mathematics 28, 55-67 (2005).
10. Haesen, S. & Verstraelen, L. Curvature and Symmetries of Parallel Transport (Chapter 8) and Extrinsic Symmetries of Parallel Transport (Chapter 9) In: M. Boucetta and J-M. Morvan (Eds) Differential Geometry and Topology, Discrete and Computational Geometry: Volume 197 NATO Science Series: Computer & Systems Sciences (2005).
11. Koiso, M. & Palmer, B. Equilibria for anisotropic energies and the Gielis Formula. Forma (Society for Science on Form, Japan) 23(1), 1-8 (2008).
12. Calhoun, D. A. & Helzel, C. A finite volume method for solving parabolic equations on logically Cartesian curved surface meshes. SIAM J Sci. Comp. 31 (6), 4066-4099 (2009).
13. Natalini, P., Patrizi, R. & Ricci, P. E. The Dirichlet problem for the Laplace equation in a starlike domain of a Riemann surface. Numer. Algor. DOl 1O.1007/s11075-008-9201-z (2008).
14. Gielis, J., Caratelli, D., Haesen, S. & Ricci, P. E. Rational mechanics and Science Rationelle Unique. In: Paipetis, S., Ceccarelli, M. (Eds.) The Genius of Archimedes: 23 centuries of influence on mathematics, science and engineering. Springer Verlag, HMMS Series 11, 29-43 (2010).
15. Lame, G. Examen de differentes methodes employees pour resoudre les problemes de geometrie. M. V. Courcier imprimeur Libraire, Paris (1818).
16. Thompson, A. C. Minkowski geometry, Encyclopedia of Mathematics and its Applications, Vol. 63, Cambridge University Press, Cambridge (1996).
17. Yajima, T. & Nagahama, Y. Finsler geometry of seismic ray path in anisotropic media. Proc. R. Soc. A 465, 1763-1777 (2009).
18. Fougerolle Y. D, Gielis J., Truchetet F. (2013) A robust evolutionary algorithm for the recovery of rational Gielis curves Pattern Recognition, Volume 46, Issue 8, August 2013, Pages 2078-2091
19. Rudek M., Canciiglieri O. JR., Jahnen A., Linck Bichinho G. (2013) CT-Slice retrieval by shape ellipses descriptors for skull repairing. 2013 IEEE International Conference on Image Processing. Sep. 15-18, 2013, Melbourne, Australia.
20. Verstraelen, L. Philosophiae Naturalis Principia Geometrica 1. Bull. Transilvania Univ. Brasov 14(49) Proc. Conf. RIGA 2007, dedicated to Radu Rosca, 335-351 (2007).
21. Koiso, M. & Palmer B. Rolling constructions for anisotropic Delaunay surfaces. Pacific Journal of Mathematics 2, 345-378 (2008).
22. Palmer B. Geometry of materials. Simon Stevin Transactions on Geometry 1, 117-129, Tilburg, The Netherlands (2010).
23. Verstraelen L. Curves and surfaces of finite Chen type. Geometry and Topology of Submanifolds Ill, World Scientific, Singapore, 304-311 (1991).
24. Caratelli, D., Natalini, P., Ricci P. E. & Yarovoy A. The Neumann problem for the Helmholtz equation in a starlike planar domain. Applied Mathematics and Computation 216(2), 556-564 (2010).
25. Caratelli, D., Natalini, P. & Ricci, P. E. Fourier solution of the wave equation for a starlike shaped vibrating membrane. Computers and Mathematics with Applications 59, 176-184 (2010).
26. Fougerolle, Y. D., Trucheret, F. & Gielis, J. A new potential function for self intersecting Gielis curves with rational symmetries. In: Proceedings of GRAPP 2009—International Conference on Computer Graphics Theory and Applications—Lisboa, Feb. 5-8, 2009.
27. Gielis Johan, Tavkelidze I., Ricci Paolo Emilio. —About “bulky” links generated by generalized Möbius—listing bodies GML(n,2). Journal of Mathematical Sciences—193(3), p. 449-460.
28. Tavkelidze I., Cassisa C., Gielis J., Ricci P. E. (2013) About “bulky” links, generated by Generalized Möbius Listing's bodies GMLn3. Atti della Accademia nazionale dei Lincei Matematica e applicazioni: 24:1: 11-38
29. Bokhabrine Y, Fougerolle Y D, Gribok A, Foufou S, Truchetet F (2007) In: Proceedings of the International Conference on Image Processing ICIP'07, San Antonio, Tex., USA, September 2007, 549-552.
30. Voisin S, Abidi M, Foufou S, Truchetet F (2009) Genetic Algorithms for 3D Reconstruction with Supershapes; Proc. of Int. Conference on Image Processing, ICIP 2009, pp. 529-532, Cairo, Egypt, IEEE, November 2009.
31. Fougerolle Y D, Truchetet F, Gielis J (2009) A new potential function for self-intersecting Gielis curves with rational symmetries. In: Proceedings of GRAPP 2009—International Conference on Computer Graphics Theory and Applications—Lisboa, Feb. 5-8, 2009.

Following the literature above, as mentioned incorporated by reference in this patent specification, the step as such of programming a computer with the aforementioned (super)formula in order to determine a set of parameters based upon given coordinates is known. In this respect, it is noted that the approaches proposed in the literature for Gielis curve and surface recovery can be classified in two families: the deterministic approaches proposed by Fougerolle et al., and stochastic approaches proposed by Bokhabrine et al., and Voisin. Both existing techniques do not handle asymmetric curves nor self-intersecting curves or surfaces, because no implicit field for such objects existed at that time. More recently, a technique to build implicit fields with guaranteed differential properties for asymmetric self-intersecting Gielis curves and surfaces has been proposed in reference 31 as cited above. The field can then be considered as distance fields. Commonly, once an initial guess, i.e. with coherent symmetries and pose, is obtained, preferably a normalized Levenberg-Marquardt algorithm efficiently determines the optimal shape parameters. The initial guess dealing with non-differentiable parameters like the symmetry parameter m, is achieved using stochastic methods like genetic or evolutionary algorithms. As a consequence, the proposed algorithm benefits from the robustness to initialization of stochastic approaches, such as evolutionary algorithms, and still remains efficient since the fine tuning of the shape and scale parameters is handled by an extension of the deterministic approaches which is able to reconstruct self intersecting asymmetric curves or surfaces. The ability to determine a Gielis curve representing complex data opens new perspectives in various research areas such as engineering, computer vision, crystallography, biology and physics, etc. In recent publications Lamé and Gielis curves and surfaces have been used, among others, in medical imaging to study the cells in dielectric properties of human skin cells in suspension, mechanical strength of leaf petioles, antenna technology and nanotechnology. The robustness of methods, even under high noise levels and for self-intersecting curves, can have significant advantages, whenever measurements are involved and interpolations of data points.

Information relating to the (preselected) coordinate system could be stored in another computer memory than the computer memory, which is used for storage of parameter related information. However, the information relating to the at least one preselected coordinate system functions as a key or map to transform the determined set(s) of parameters back to the original information, preferably in a lossless manner. Without this key or map, it is imaginable that the set(s) of parameters as such are useless and cannot be transformed in opposite direction to regenerate (recover) the original information. Of course, it is also imaginable that all information is stored, preferably as cross-reference, in at least one central computer memory, such as a database.

In the choice of the coordinate systems the said formulae allow for stretching the coordinate system and the position vectors (from a central point), with specific choices of the parameters. However, parameters can be defined not as single values, but also as a range. This allows for defining not merely shapes but to extend this concept to n-dimensional spaces.

The variable length of the radius vector for Lamé curves can be carried through to lₚ spaces. This space X of all sequences x=(x₁, x₂, . . . ) of real numbers for which

$${( {\sum }_{k = 1}^{∞} {\vert {x}_{k} \vert}^{p} )}^{1 / p} < ∞ ( p \geq 1 )$$

and for which the distance

$${d}_{p} = {( {\sum }_{k = 1}^{∞} {\vert {x}_{k} - {y}_{k} \vert}^{p} )}^{1 / p}$$

with (X,d) is a complete metric space namely lp. In such spaces the exponent p is a constant value in all dimensions. The choice of the coordinate system however is not restricted to a fixed value of p, but the space of all lp spaces or subsets thereof is considered, and their intrinsic coordinate systems. In considering a problem for example p∈[2;∞[or p∈[2;5.5] for a specific problem. The first interval is general, while the second is specific, e.g. in a problem where previous knowledge has confined the range of n from 2 to 5.5. This allows to finalize the computation in natural coordinate systems, for example by computing action, e.g. with a prescribed value of area or volume or a similar penalty function to determine the value of n for the problem under study, whereby this becomes a variational problem in lₚ spaces.

These lₚ spaces can be generalized with the formulae as mentioned in claim 1, since Lamé curves are special

cases. With said formulae a generalization of lₚ spaces, and in a similar way any of the parameters can be defined to belong to an interval of values, rather than a specific value. Also here, boundary conditions like action turns this into an integral problem to define the precise values of the spaces and all subspaces. A specific example concerns Fourier series, which define a multidimensional space based on the unit circle. With a generalized Fourier series, not only a generalized space using supershapes can be defined by said formulae, but all shapes co-exist in such spaces, whereby in each subspace the coordinate systems are not isotropic, but anisotropic, with a dedicated number system on the coordinate axes. However, equivalent to expressing shapes into a finite number of terms in a Generalized Fourier Series, a finite dimensional space of coordinate systems can be build for each problem at hand. For all Lamé curves or supershapes, this means that an infinite dimensional space, can be converted into a lower dimensional space. In the continuing search for dimensionality reduction, this is a major step.

In order to recompile (regenerate) the information based upon determined set(s) of parameters, it could be favourable to define one or more coordinate (reconstruction) definitions, preferably during step B) and/or step D). This type of coordinate definitions commonly facilitates recovering of the original coordinates relating to the original information. This definition includes commonly information, in particular one or more threshold values, determining the situation when a coordinate, which is intersected by a Gielis curve generated during recovering of information, should be considered as a coordinate to be taken into account for the regeneration of the original information. These threshold values could include for example, the minimum extent of intersection of an outlined space relating to a coordinate and/or a minimum or maximum angle of intersection of a Gielis curve of an outlined space relating to a coordinate. Also the at least one coordinate reconstruction definition, if applied, is preferably stored in a computer memory, preferably a database, during step E), more preferably as cross-reference to the at least one preselected coordinate system used during step B), and the first set of parameters and/or second set of parameters determined during step D).

The parameters found during step D) are preferably subjected to a minimization problem approach using a statistical optimal technique, preferably a non-linear least-squares approach, in particular the (iterative) Levenberg-Marquardt (LM) algorithm. In particular parameters n₁, n₂, and n₃ can be minimized efficiently by using a statistical optimal technique. The most efficient methods in the literature apply the Levenberg-Marquardt's method, which is based on efficient approximations of the Hessian matrix and gradient of the cost/potential function. The key idea is to transform the potential fields such that they behave as an approximation of a distance function to the curve through normalization. The evolutionary algorithm has a linear complexity in function of the population size and the number of iterations, so the results presented correspond to the computational time for one iteration divided by the population size. Once an initial guess, i.e. with coherent symmetries and pose, is obtained, the normalized Levenberg-Marquardt algorithm efficiently determines the optimal shape parameters. As a consequence, the proposed algorithm benefits from the robustness to initialization of stochastic approaches and still remains efficient since the fine tuning of the shape and scale parameters is handled by an extension of the deterministic approaches which is able to reconstruct self intersecting asymmetric curves or surfaces.

The parameters can further be optimized, in particular minimized, to occupy as little memory as possible, by searching for the optimum (ideal) combination of parameters, and consecutively by condensing at least one parameter value. For example, the equation xⁿ¹+yⁿ²=12 has an infinite number of solutions (x;y;n₁;n₂) including solution A (2;3;2;2) and solution B (2;8;3,5;1.02915428), wherein solution A is preferred over solution B, since solution A would take up less memory space.

The set of coordinates to be created during step B) may be of a very diverse type, and goes further than a typical Cartesian coordinate system. It is even conceivable for the information already to be supplied during step A) as a set of coordinates, whereby step A) and step B) take place simultaneously, or step B) can be omitted completely. It is thus conceivable, for example, that specific discrete measurement values have to be analysed as a function of time, whereby these time-dependent measurement values can be analysed directly as a set of coordinates by the computer during step D). A coordinate could be defined here, for example, as (x, y), wherein x represents a moment in time and y represents a measured measurement value. Countless other examples are obviously conceivable. It is also conceivable for at least one parameter to be entered directly during step A), step B) and/or step D), so that the subsequent analysis is simplified. For example, a measurement value can be regarded directly as a value of parameter n₁. It furthermore becomes clear that, although the formula(e) is/are supplied with at least one set of coordinates, consisting of discrete coordinates (information points), the ultimate at least one set of parameters is a continuous collection of data, wherein values lying between the entered coordinates also form part of the data which are stored in the computer memory.

The information will usually be projected during step B) in at least one predefined n-dimensional geometric space, as a result of which the at least one set of coordinates is formed. This geometric space may, in particular, be of a simple type and may be formed, for example, by a 2-dimensional matrix, but may also be of a 3-dimensional type, or may even have more dimensions. By converting the information into one or more sets of coordinates and projecting the set of coordinates in a geometric space, of whatever type, a dot pattern can be implemented through which one or more curves and/or bodies of revolution are fitted by using said formulae, resulting in the required parameter values which are then stored in a computer memory. The first set of parameters will in any case be stored here and possibly, in addition, the second set of parameters. The first set of parameters can be formed by the set {A, B, m₁, m₂, n₁, n₂, n₃}, but it is also conceivable to reduce the number of parameters of this set given that parameters with different designations may have identical values and/or that one or more parameters may have default values. It is thus conceivable that m₁ is equal to m₂, as a result of which it would suffice to store only one value for m. It is similarly conceivable for at least one default value to be assigned to m₁ and m₂, such as, for example, the typical value “4”. The first set of parameters which is stored may thus have fewer parameters than the set {A, B, m₁, m₂, n₁, n₂, n₃}, but will preferably comprise at least the set {A, B, n₁, n₂, n₃}, more preferably at least the set {A, B, m, n₁, n₂, n₃}, and even more preferably the complete set {A, B, m₁, m₂, n₁, n₂, n₃}. The second set of parameters which is formed by {Θ, k} is particularly advantageous if more complex n-dimensional (n≧3) graphical representations result from the analysed information.

The set of coordinates and the arrangement of the geometric space may be based on a Cartesian coordinate system, but these may also be coordinate systems of a different type, even self-designed. The geometric space will preferably be provided with basic characters which are distributed at predefined locations over the geometric space. The geometric space will also preferably have a centre, whereby a reference point is created in relation to which the set of coordinates is expressed. As an example, the following simple geometric space with discrete information points (A, B, C, D, E, F) is proposed:

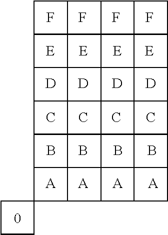

In this case, the geometric space relates to a 6×4 matrix, with a zero point at the bottom left as the centre (reference). If the information to be analysed consists of the word “FADE”, the information can be projected in said (simplified) space, thereby producing a set of coordinates which can be represented as follows:

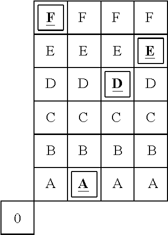

Said set of coordinates can be used to fit through, in this case, a curve which, following iteration using the computer, results in the curve:

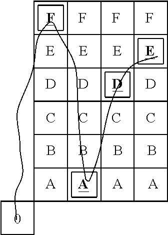

and therefore in the parameters of the first set of parameters which are stored in a computer memory. This curve touches only the information points (letters) which occur in the word to be analysed. Other information points are not touched and are therefore ignored. Instead of a curve, vectors or bodies of revolution can also be used to create a graphical representation of the word “FADE”. In the same way, much larger pieces of information can be converted via sets of coordinates into curves, bodies of revolution, or shapes of other types which can be described by means of the first formula and possibly the second formula. It is obviously conceivable for information to be converted into a plurality of sets of coordinates and consequently a plurality of sets of parameters. In this way, more information can be analysed and stored, and it is also possible to analyse and store more details relating to the information. With regard to this last aspect, it is conceivable, for example, in analysing the word “FADE”, for a first geometric space to be configured in accordance with said matrix in order to determine the letters used and the order thereof, for a second geometric space to be configured in order to determine the colour of the font of the word “FADE”, for a third geometric space to be configured in order to determine the font of the word “FADE”, for a fourth geometric space to be configured in order to determine the font size of the word “FADE”, etc. Said geometric spaces can possibly be integrated with one another at least partially, thereby creating a more complex geometric space. Optionally, the centre of the geometric space is also stored in a computer memory during step E), eventually as a part of the information relating to the preselected coordinate system(s).

It is conceivable for the at least one set of parameters to be printed on a physical medium, preferably by means of a printer, usually a 2D printer or 3D printer. In the case of 2D printing, a two-dimensional view of the graphical representation associated with the set of parameters is printed. It is also conceivable for only the values of the parameters of the set of parameters to be printed, i.e. to be stored, on a physical medium. This printing can possibly be carried out in encrypted, in particular steganographic, form. In the case of 3D printing, for example, the graphical representation associated with the at least one set of parameters can be printed as an object, this also being regarded as a type of storage. The original set of parameters stored in the computer memory can be retained or deleted after printing as required.

If a plurality of sets of coordinates are converted into corresponding sets of parameters, it is advantageous for the sets of parameters to be stored with a cross-reference in the computer memory during step E). A data collection is created in this way. It is also conceivable to create a data collection during step E) on the basis of a single set of parameters to which different types of data have been added, such as, for example, an identification number, a representation of the information, etc. The digital storage of the data collection can also result in the construction of a database in the computer memory. The different records of the database may relate here to the same piece of information, but may also relate to different pieces of information.

Databases are an essential component of the information society, wherein increasing amounts of data are stored in a database (data bank). The functioning of the government, businesses and science is presently inconceivable without databases. It is important that data can easily be created in the database (Create), and can be permanently stored (Save/Store) and searched (Read), updated (Update) and preferably also that stored data can be removed relatively easily without adversely affecting the operation of the database (Delete). If the database data are formed by digital representations of graphical representations, such as, for example, images or other types of visual representations, a constant effort is made to limit the volume of data stored in the database as much as possible without compromising the quality of the alternative, parameter-based representation of the original information, thereby increasing the capability for fast and efficient working with the database.

In searching for data in the data collection, a direct search can be performed on the basis of values of sets of parameters, in particular at least one set of parameters, wherein it is also conceivable for a searched pattern first to be converted by means of one or both of said formulae into one or more sets of parameters which are then entered as a search query in the data collection.

In a preferred embodiment, the method also comprises step F), comprising the allocation of an identification code to the information, wherein the identification code and the related at least one set of parameters are stored in the data collection as a cross-reference during step E). The identification code can considerably simplify the ability to find patterns associated with stored sets of parameters. The identification code may comprise a plurality of segments, including, for example, a date-related or time-related moment, or, for example, a segment describing the information.

In a preferred embodiment, the method also comprises step G), comprising the allocation of user-defined information to the graphical representation, and the storage in the data collection of the user-defined information as a cross-reference to the at least one set of parameters during step D). User information of this type can possibly simplify the interpretation of sets of parameters and, on the basis thereof, newly generated digital and/or physical graphical representations. It is, for example, also conceivable for a digital photo (screenshot) of the information to be stored as a cross-reference in the data collection. Here, the photo is preferably compressed, wherein the photo format is possibly reduced before the photo is stored. The photo usually has, in particular, an informative purpose in order to retrieve an image of the original physical graphical representation quickly and simply, which could simplify the interpretation of data from the data collection.

It is usually advantageous if the method also comprises step H), comprising the determination of tolerance values for the at least one set of parameters determined during step D), and the storage of the determined tolerance values in the data collection as a cross-reference to the related set of parameters. Through the determination and storage of tolerance values, a collection is created de facto of patterns which bear a strong resemblance to the original information (which can be regarded as a pattern). This makes it relatively easy to convert restrictedly deviating patterns into an already stored representation of a physical pattern. From the point of view of intellectual property rights to aesthetic designs (graphical representations), this can be advantageous, since similar designs can be linked relatively quickly and simply in this way to one or more already stored designs, which, for example, can considerably simplify the detection of infringing parties and/or plagiarism. It is conceivable here for the original pattern of the owner to be stored in the data collection and for competing patterns to be analysed and subsequently compared with the original pattern. However, the opposite situation is also conceivable, wherein, for example, a digital auction site, such as, for example, eBay, or at least a part thereof, is analysed, wherein the objects (patterns) offered are stored temporarily or otherwise as sets of parameters in a data collection, by means of which an owner of an aesthetic design can relatively easily identify similarly designed objects. Various other applications are obviously also conceivable. At least one tolerance value is preferably allocated to each parameter, as a result of which an upper limit and a lower limit of each parameter, and thereby a range around the relevant parameter, are determined. The tolerance values can be set manually, wherein a user or a different person, for example, sets lower limits and/or upper limits for each parameter and/or for each set of parameters. It is also conceivable for a computer to determine these tolerance values, for example on the basis of empirical observations or on the basis of one or more (search) algorithms. Different types of statistical methods can also be applied for the determination—usually automated by means of a computer—of tolerance values to be applied. The determination of the tolerance values can be performed before, during and/or after the analysis during step C) of the digitised graphical representation. As an example of the automated determination of tolerance values, reference is made to the American patent specification US2012/0233188, the content of which is deemed to form part of this patent specification.

The information which is stored in the computer memory in the form of one or more sets of parameters may be of a very diverse type. The information can be represented by means of one or more sets of coordinates in a geometric space which may be both two-dimensional and three-dimensional and also possibly four-dimensional (dynamic through time). The information may relate to a physical object, a part of a physical (three-dimensional) object, or a combination of (parts of) physical objects. Both an internal shape (inner circumference) and an external shape (outer circumference) of the object can be analysed here. The pattern may also be formed by a (two-dimensional or three-dimensional) image, such as, for example, a photo, a stereo image, or a hologram. The image may also change through time, thereby creating, for example, a video film. It is conceivable for such moving images also to be analysed and stored in a coherent data collection, which will be described in detail below. It is furthermore conceivable for the information to relate to at least a part of a representation of an electromagnetic wave, sound wave or sound pattern, a wavelet, a spray, or at least a part of a DNA molecule, or other type of pattern. It is conceivable here, for example, to analyse a musical work and store it by means of one or more sets of parameters by applying the method according to the invention. The method according to the invention can also be applied to identify road signs. In this respect, a two-stage detection analysis could be performed, wherein during a first stage, road signs are located in images based on color segmentation, wherein in a second stage and their corresponding shape is retrieved using a unified shape representation based on Gielis curves. The shape reconstruction method permits to detect any common road sign shape, i.e. circle, triangle, rectangle and octagon, by a single algorithm without any training phase. The method according to the invention could also be used for other purposes, such as face recognition. However, it is also conceivable for at least a part of the information to relate to information, in particular textual information and/or numerical information. Textual information is made up of letters and possibly digits and/or punctuation marks which, as a sequence of characters, can be regarded as a graphical representation which can be subjected to the method according to the invention. In this way, it is possible to store text passages or even complete texts in reduced form by means of one or more sets of parameters in a data collection. Numerical information may relate to specific digits or numbers for which storage in the data collection is required. However, the numerical information preferably relates to a notation or numbering system. Examples of this are the binary system and the octal and hexadecimal system related thereto. Other numbering systems, such as the duodecimal system, the sexagesimal system and the decimal system are other examples of numbering systems which can be subjected to the method according to the invention. Since the memory cells of computers can assume two values, this involves a binary representation of the stored information. Numbers are therefore represented internally in computers as binary numbers. For the outside world, these numbers are usually translated into the hexadecimal or octal system, which are both closely related to the binary numbering system. By regarding a binary sequence as a graphical representation, the binary sequence can be stored in substantially reduced form by means of one or more sets of parameters. A computer configured to process sets of parameters as determined during step C) has to process significantly less information per time unit, thereby considerably improving the handling speed of the computer. It is also conceivable for the information to relate to quantum computers, in particular quantum particles, whether or not entangled and superposed, and/or time-dependent quantum states of quantum particles of this type. Other applications of the above are obviously also conceivable.

If the original information is not yet available in digital format, the information will be digitised in step A). The information is preferably digitised during step A) in such a way that no or hardly any quality loss will occur compared with the original physical information, so that the digital form substantially completely matches the form of the physical information. Step A) usually takes place by means of the scanning of the information. The scanning can be performed in a 2D environment and also in a 3D environment. The digital image generated in step A) is usually stored temporarily, for example in the computer memory of the computer, for the subsequent analysis which will take place in step D). Generally, but not necessarily, the scanned image, usually with a relatively large file size, will be deleted following the analysis, since the same image is already stored in substantially more compact format, i.e. in the form of one or more sets of parameters, in the data collection during step E).

The at least one set of parameters can be stored in the computer memory in a volatile, semi-volatile and/or permanent manner, depending on the type of computer memory and the further purpose of the stored information. It is conceivable, for example, to use an external memory of a computer for this purpose. In contrast to internal memory of a computer, this external memory is a form of storage for data outside the motherboard of the computer. External memory can be connected via wiring to the motherboard. External memory is also referred to as permanent memory; this memory retains the information even if all electrical voltage is removed from the memory, in contrast to an internal memory. Typical examples of external memories are: a hard disk, a solid-state drive (SSD), a diskette, an optical disk, such as a CD-ROM, DVD or Blu-ray, a tape streamer and flash memory. The external memory is normally used if the data need to be stored for a longer period (at a specific location). An archive can be built up here from a plurality of sets of parameters associated respectively with a plurality of graphical representations. This archive can then be used for a plurality of purposes, including the comparison of information with graphical representations of information already stored in the database. This application is further examined below in the present patent specification. Instead of an external memory, the at least one set of parameters, in particular the digital database, can also be stored in an internal memory. The internal memory refers to computer memory which is located on the motherboard. In the memory hierarchy, it is referred to as the first layer of memory, the primary memory. A distinction is traditionally made for the internal memory between cache memory which is located (physically) very close to a CPU (processor) and the RAM memory. The internal memory is very fast and therefore causes little delay in the retrieval and storage of data. The at least one set of parameters can be stored digitally in volatile form in the internal memory of the computer. This form of storage is particularly useful if the at least one set of parameters is further processed immediately or almost immediately after storage, and, in particular, is transmitted digitally to a different location via a network connection and/or the Internet. Since the information is substantially reduced by applying the method according to the invention, the at least one set of parameters can be transmitted relatively easily to a different location via a network connection and/or the Internet. The at least one set of parameters, a data collection related hereto, can be transmitted, for example, via e-mail. The at least one set of parameters, a data collection related hereto, or at least a part thereof, can be uploaded to, for example, an online Cloud service for the online storage of files, such as, for example, Dropbox®, Google Drive®, or iCloud®. It is furthermore conceivable for a set of parameters, a data collection related hereto, stored in volatile form in the internal memory, or a part thereof, to be streamed to a different network component, such as a different computer and/or a monitor.

The computer which is configured to carry out step D) will usually comprise one or more processors which are configured to match the parameter values associated with an (artificial) pattern which substantially completely matches the graphical representation. Here, the computer will usually be provided with memory in which it can temporarily store data which are used during the analysis. The computer can also be formed by a server which is accessible, for example, via a LAN network and/or WAN network.

In order to be able to analyse the information by means of the method according to the invention, it is advantageous if the computer is configured to divide up the information to be analysed into a plurality of smaller information portions, wherein each information proportion is converted into at least one set of coordinates which is then transformed by means of the first formula and possibly the second formula into one or more sets of parameters. This makes it possible to convert relatively complex shapes, such as combined shapes, also into sets of parameters and to store them as such in the data collection. Known CSG techniques (Constructive Solid Geometry techniques), variants thereof or comparable techniques are generally used here. It is also conceivable for one or more information portions to be selected manually, which may be advantageous if a user is only interested in storing a part of an information portion.

It is conceivable to store the data during step E) in encrypted (coded) form in the computer memory. As a result, the data collection is protected, whereby an access control can be applied for the purpose of not allowing unauthorised persons to access data of this type. Data and/or the data collection as such can be protected in known ways.

In an alternative embodiment, the method comprises step I), comprising the transfer, in particular uploading, of the digital information to the computer before the digital information is analysed by means of the computer during step D). It may be advantageous here if an authentication step is carried out during step I), wherein a user wishing to initiate a transfer is authenticated and the digital information is transferred to the computer only following authentication of the user. The user will thus be able to make contact with the computer in order to effect the storage of the digital information and the set(s) of parameters obtained herefrom only following authentication and the possible fulfilment of further conditions, such as, for example the making of a payment. The same authentication of a user can also be imposed on the intention to consult data which are stored in the computer memory.

The information can be formed by an image, and also by a dynamic image which transforms through time. The information can thus also be formed by a video, which concerns a dynamic pattern which undergoes a time-dependent transformation. It is therefore conceivable for a plurality of digital images, chronological or otherwise, to be generated from the combination of static images (frames) during step A), said images being analysed individually during step D), and wherein the sets of parameters obtained during step D) are stored in a data collection as a cross-reference to one another during step E). The sequence of static images which jointly, for example, form a video is stored as a representative sequence of sets of parameters in the data collection during step E). Data relating to the number of patterns per time units, in particular the number of frames (images) per second (fps), can possibly also be stored here in the data collection, so that the dynamic pattern can again be synthesised (reconstructed) as accurately as possible.

The invention also relates to a method for digital transmission of information, comprising the following steps: converting information into at least one first set of parameters and/or at least one second set of parameters by applying said method according to the invention, and digitally transmitting at least one first set of parameters and at least one second set of parameters to a digital location. The location may be formed here, for example, by an IP address, an e-mail address, and/or a website. By significantly reducing the size of the (digital) graphical representation, in bytes, by converting the conventional file format of the graphical representation into a much smaller, parameter-based file format, the network traffic load can be substantially reduced, wherein the graphical representation, or at least a part thereof, can furthermore be digitally exchanged more quickly.

The invention furthermore relates to a method for consulting information which is stored according to said method in a computer memory, wherein the graphical representation to be consulted is synthesised and visualised on, for example, a monitor and/or by physically printing the pattern by means of known 2D and/or 3D printing techniques. It is also conceivable to enter one or more search criteria into the computer, said search criteria, or at least a part thereof, being converted into one or more sets of parameters on the basis of which related sets of parameters can be searched, whereafter the information found can be visualised in any way whatsoever.

The invention then relates to a method for comparing information, comprising the following steps:
K) providing a data collection, in particular a digital database, in which first sets of parameters and/or second sets of parameters associated with information are stored according to the method according to one of the preceding claims,
L) providing the information to be compared in digital format,
M) converting the digital information to be compared into at least one set of coordinates,
N) programming a computer with at least one first formula:

$$ρ ( ϑ ; f ( ϑ ) , A , B , {m}_{1 , 2} , {n}_{1} , {n}_{2} , {n}_{3} ) = f ( ϑ ) [ \vert \frac{1}{A} cos \frac{{m}_{1} ϑ}{4} \vert \text{?} + / - \vert \frac{1}{B} sin \frac{{m}_{2} ϑ}{4} \vert \text{?} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by A, B, m₁, m₂, n₁, n₂, n₃, and
wherein a second set of parameters is formed by [symbol] and k.
and wherein the computer is preferably also programmed with a second formula:

$$P ( ϑ ) = \text{?} {ρ}_{i} ( ϑ ; {f}_{j} ( ϑ ) , {A}_{j} , {B}_{j} , {m}_{1 j , 2 j} , {n}_{1 j} , {n}_{2 j} , {n}_{3 j} )$$

$$\text{?} \text{indicates text missing or illegible when filed}$$

said second formula being a summation of a plurality of first formulae;
O) analysing the at least one set of coordinates obtained during step M) in the computer in order to determine a generalised comparison for the information, wherein the values for the first set of parameters, and preferably also the values for the second set of parameters, are determined; and
P) comparing the first set of parameters and/or second set of parameters associated with the information to be compared with the first sets of parameters and/or second sets of parameters as stored in the data collection, in particular the digital database.

It is advantageous here if the method also comprises step Q), comprising the presentation of a result of the comparison subsequent to the comparison of the first set of parameters and/or second set of parameters associated with the information to be compared with the first sets of parameters and/or second sets of parameters as stored in the data collection according to step P). This presentation may be visual, but may also be performed audibly by means of a sound signal. A combination of both is also conceivable. In an advantageous example embodiment, step H) is also applied during step K), comprising the determination of tolerance values for the at least one set of parameters determined during step D), said determined tolerance values being stored in the data collection as a cross-reference to the related set of parameters, and wherein, during step P), the first set of parameters and/or second set of parameters of the pattern to be compared are compared with the range which is defined by the tolerance values stored in the data collection. Advantages of this method according to the invention have already been described in detail above.

The invention also relates to a method for regenerating information which is stored as a representation in a computer memory after applying the method according to the invention, comprising the steps:
R) reading at least one computer memory, preferably a digital database, wherein at least one cross-reference is stored between the at least one preselected coordinate system used during step B), and the first set of parameters and/or second set of parameters determined during step D),
S) calculating at least one set of coordinates by entering the parameters read during step R) into a computer programmed with at least one first formula:

$$ρ ( ϑ ; f ( ϑ ) , A , B , {m}_{1 , 2} , {n}_{1} , {n}_{2} , {n}_{3} ) = f ( ϑ ) [ \vert \frac{1}{A} cos \frac{{m}_{1} ϑ}{4} \vert \text{?} + / - {\vert \frac{1}{B} sin \frac{{m}_{2} ϑ}{4} \vert}^{{n}_{2}} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by the parameters A, B, m₁, m₂, n₁, n₂, and/or n₃, and wherein a second set of parameters is formed by [symbol] and k.
and wherein the computer is preferably also programmed with a second formula:

$$P ( ϑ ) = \text{?} {ρ}_{i} ( ϑ ; {f}_{j} ( ϑ ) , {A}_{j} , {B}_{j} , {m}_{1 j , 2 j} , {n}_{1 j} , {n}_{2 j} , {n}_{3 j} )$$

$$\text{?} \text{indicates text missing or illegible when filed}$$

said second formula being a summation of a plurality of first formulae; and
T) converting the calculated coordinates into the original digital information.

In fact this recovering method works in the opposite way compared to the method for analysing and storing information as described above. In order to facilitate concrete coordinates related to the original information, it s preferred that during step S) at least one coordinate reconstruction definition is used. Examples of such a definition have been given above. The coordinate reconstruction definition is preferably read from the computer memory during step R), and may eventually make part of the information relating to the coordinate system. Preferably, said at least one coordinate reconstruction definition comprises a definition of an outlined coordinate space of the coordinates of the coordinate system, which allows an easy determination of which coordinates make part of the selection of original coordinates (originating from the original information) and which coordinates could be disregarded.

The invention furthermore relates to a system for analysing information and for storing a representation related to the information in a computer memory, in particular by applying the method according to the invention, comprising:
K) at least one first computer configured to convert digital information into at least one set of coordinates;
L) at least one second computer programmed with at least one first formula:

$$ρ ( ϑ ; f ( ϑ ) , A , B , {m}_{1 , 2} , {n}_{1} , {n}_{2} , {n}_{3} ) = f ( ϑ ) [ \vert \frac{1}{A} cos \frac{{m}_{1} ϑ}{4} \vert \text{?} + / - {\vert \frac{1}{B} sin \frac{{m}_{2} ϑ}{4} \vert}^{{n}_{2}} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by A, B, m₁, m₂, n₁, n₂, n₃, and
wherein a second set of parameters is formed by [symbol] and k.
and wherein the computer is preferably also programmed with a second formula:

$$P ( ϑ ) = \text{?} {ρ}_{i} ( ϑ ; {f}_{j} ( ϑ ) , {A}_{j} , {B}_{j} , {m}_{1 j , 2 j} , {n}_{1 j} , {n}_{2 j} , {n}_{3 j} )$$

$$\text{?} \text{indicates text missing or illegible when filed}$$

said second formula being a summation of a plurality of first formulae, wherein the second computer is also configured to analyse the at least one set of coordinates determined by the first computer in order to determine a generalised comparison for the information, wherein the values for the first set of parameters, and preferably also the values for the second set of parameters, are determined; and
   at least one computer memory for storing the first set of parameters and/or second set of parameters determined by means of the second computer. The first computer and the second computer may be formed here by the same computer. It is also conceivable for at least one computer memory to form part of the second computer. The first computer will usually be programmed to project the information in a predefined n-dimensional geometric space, as a result of which at least one set of coordinates is formed.

If the information is not yet available in digital format, it is advantageous if the system comprises a scanning device to digitise the information. Here, the computer will usually be connected to the scanning device. The computer is also preferably connected to a monitor to visualise stored and/or consulted synthesised patterns. The computer is also preferably connected to a printer, in particular a 3D printer, to enable printing, if required, of one or more stored patterns. As already indicated, the computer usually comprises one or more processors which are configured to match the parameter values associated with an (artificial) pattern which substantially completely matches the graphical representation. Here, the computer will usually be provided with memory in which it can temporarily store data which are used during the analysis. The computer can be formed by a server which is accessible (online), for example via a LAN network and/or WAN network.

Preferred features of the invention are set out in the following clauses:

1. Method for analysing information and storing a representation related to the information in a computer memory, comprising the steps:
A) providing the information to be analysed in digital format,
B) converting the digital information into at least one set of coordinates,
C) programming a computer with at least one first formula:

$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - \vert \frac{1}{B} sin \frac{{m}_{2} ϑ}{4} \vert \text{?} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by the parameters A, B, m₁, m₂, n₁, n₂, and/or n₃, and wherein a second set of parameters is formed by [symbol] and k.
and wherein the computer is preferably also programmed with a second formula:

$$P ( ϑ ) = \text{?} {ρ}_{i} ( ϑ ; {f}_{j} ( ϑ ) , {A}_{j} , {B}_{j} , {m}_{1 j , 2 j} , {n}_{1 j} , {n}_{2 j} , {n}_{3 j} )$$

$$\text{?} \text{indicates text missing or illegible when filed}$$

said second formula being a summation of a plurality of first formulae;
D) analysing the digital information in the computer on the basis of the at least one set of coordinates in order to determine at least one generalised comparison for the information, wherein the values for the first set of parameters, and preferably also the values for the second set of parameters, are determined; and
E) storing in a computer memory the first set of parameters and/or second set of parameters determined during step D).
   2. Method according to clause 1, wherein the information is projected during step B) in at least one predefined n-dimensional geometric space, as a result of which the at least one set of coordinates is formed.
   3. Method according to clause 2, wherein the geometric space is provided with basic characters which are distributed at predefined locations over the geometric space.
   4. Method according to clause 2 or 3, wherein each geometric space is provided with at least one centre.
   5. Method according to clause 4, wherein each set of coordinates determined during step B) is relative in relation to the centre of the geometric space concerned.
   6. Method according to one of the preceding clauses, wherein at least one body of revolution is determined during step D) on the basis of the set of coordinates, said body of revolution being related to at least one set of parameters.
   7. Method according to one of the preceding clauses, wherein the digital information is converted during step B) into a plurality of sets of coordinates.
   8. Method according to clause 7, wherein the information is projected during step B) in a plurality of predefined n-dimensional geometric spaces, as a result of which the plurality of sets of coordinates are formed.
   9. Method according to one of the preceding clauses, wherein the at least one determined set of parameters stored during step E) forms part of a data collection stored in the computer memory.
   10. Method according to clause 9, wherein the method also comprises step F), comprising the allocation of an identification code to the representation, wherein the identification code and the related at least one set of parameters are stored in the data collection as a cross-reference during step E).
   11. Method according to clause 9 or 10, wherein at least one digital photo is taken of the information during step A), wherein the at least one digital photo is stored in the data collection as a cross-reference to the related set of parameters during step E).
   12. Method according to one of clauses 9-11, wherein the method also comprises step G), comprising the allocation of user-defined information to the graphical representation, and the storage during step E) of the user-defined information as a cross-reference to the at least one set of parameters in the data collection.
   13. Method according to one of clauses 9-12, wherein the method comprises step H), comprising the determination of tolerance values for the at least one set of parameters determined during step D), and the storage during step E) of the determined tolerance values in the data collection as a cross-reference to the related set of parameters.
   14. Method according to one of clauses 9-13, wherein a plurality of sets of parameters are stored during step E).
   15. Method according to one of clauses 9-14, wherein the data collection is created during step E).
   16. Method according to one of clauses 9-15, wherein the data collection relates to a digital database.
   17. Method according to one of clauses 9-16, wherein the digital information is converted into a plurality of sets of coordinates during step B), wherein each set of coordinates is analysed in the computer during step D) in order to determine at least one generalised comparison for the set of coordinates, wherein the values for the first set of parameters, A, B, n₁, n₂, n₃, m₁ or m₂, and preferably also the values for the second set of parameters Θ and k, are determined, and wherein the first set of parameters and/or second set of parameters associated with each set of coordinates is/are stored in the data collection during step E).
   18. Method according to one of clauses 9-17, wherein the information relates to a dynamic pattern which is subjected to a time-dependent transformation.
   19. Method according to clause 18, wherein a plurality of chronological digital images are generated in step A) from the dynamic pattern, said chronological images being individually converted into at least one set of coordinates during step B) and being analysed during step D), and wherein the sets of parameters obtained during step D) are stored in the data collection as a cross-reference to one another during step E).
   20. Method according to clause 18 or 19, wherein the dynamic pattern relates to a video.
   21. Method according to one of the preceding clauses, wherein the information relates to at least a part of a physical object and/or image.
   22. Method according to one of the preceding clauses, wherein the at least a part of the information relates to textual information and/or a numerical representation.
   23. Method according to one of the preceding clauses, wherein the information relates to at least a part of a representation of a wave.
   24. Method according to one of the preceding clauses, wherein physical information is digitised during step A).
   25. Method according to one of the preceding clauses, wherein the method also comprises step I), comprising the transfer of the digital information to the computer before the digitised graphical representation is analysed during step D) by means of the computer.
   26. Method according to clause 25, wherein step I) also comprises an authentication step wherein a user wishing to initiate a transfer is authenticated and the digital information is transferred to the computer only following authentication of the user.
   27. Method according to one of the preceding clauses, wherein the at least one set of parameters is stored during step E) in an internal memory of a computer.
   28. Method according to one of the preceding clauses, wherein the at least one set of parameters is stored during step E) in an external memory of a computer.
   29. Method according to one of the preceding clauses, wherein the data stored during step E) are stored in encrypted form in the computer memory.
   30. Method according to one of the preceding clauses, wherein the method also comprises step J), comprising the digital transmission of at least one set of parameters stored during step E) to a different location.
   31. Method according to one of the preceding clauses, wherein a graphical representation of the at least one set of parameters determined during step D) is physically printed during step E).
   32. Method for comparing information, comprising the steps:
K) providing a data collection, in particular a digital database, in which first sets of parameters and/or second sets of parameters associated with information are stored according to the method according to one of the preceding clauses,
L) providing the information to be compared in digital format,
M) converting the digital information to be compared into at least one set of coordinates,
N) programming a computer with at least one first formula:

$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - {\vert \frac{1}{B} sin \frac{{m}_{2} ϑ}{4} \vert}^{{n}_{2}} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by A, B, m₁, m₂, n₁, n₂, n₃, and
wherein a second set of parameters is formed by [symbol] and k.
and wherein the computer is preferably also programmed with a second formula:

$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$

said second formula being a summation of a plurality of first formulae;
O) analysing the at least one set of coordinates obtained during step M) in the computer in order to determine a generalised comparison for the information, wherein the values for the first set of parameters, and preferably also the values for the second set of parameters, are determined; and
P) comparing the first set of parameters and/or second set of parameters associated with the information to be compared with the first sets of parameters and/or second sets of parameters as stored in the data collection, in particular the digital database.
   33. Method according to clause 32, wherein the method comprises step Q), comprising the presentation of a result of the comparison subsequent to the comparison of the first set of parameters and/or second set of parameters associated with the information to be compared with the first sets of parameters and/or second sets of parameters as stored in the data collection, in particular the digital database, according to step P).
   34. Method according to clause 32 or 33, wherein step H) is also applied during step K), comprising the determination of tolerance values for the at least one set of parameters determined during step D), said determined tolerance values being stored in the data collection as a cross-reference to the related set of parameters, and wherein, during step P), the first set of parameters and/or second set of parameters of the graphical representation to be compared are compared with the range which is defined by the tolerance values stored in the data collection.
   35. System for analysing information and storing a representation related to the information in a computer memory, in particular by applying the method according to one of clauses 1-31, comprising:
at least one first computer configured to convert digital information into at least one set of coordinates;
at least one second computer programmed with at least one first formula:

$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - {\vert \frac{1}{B} sin \frac{{m}_{2} ϑ}{4} \vert}^{{n}_{3}} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by A, B, m₁, m₂, n₁, n₂, n₃, and
wherein a second set of parameters is formed by [symbol] and k.
and wherein the computer is preferably also programmed with a second formula:

$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$

said second formula being a summation of a plurality of first formulae, wherein the second computer is also configured to analyse the at least one set of coordinates determined by the first computer in order to determine a generalised comparison for the information, wherein the values for the first set of parameters, and preferably also the values for the second set of parameters, are determined; and
   at least one computer memory for storing the first set of parameters and/or second set of parameters determined by means of the second computer.
   36. System according to clause 35, wherein the first computer and the second computer are formed here by the same computer.
   37. System according to clause 35 or 36, wherein at least one computer memory forms part of the second computer.
   38. System according to one of clauses 35-37, wherein the first computer is programmed to project the information in a predefined n-dimensional geometric space, as a result of which at least one set of coordinates is formed.

The invention will be explained with reference to non-limiting example embodiments shown in the following figures, in which:

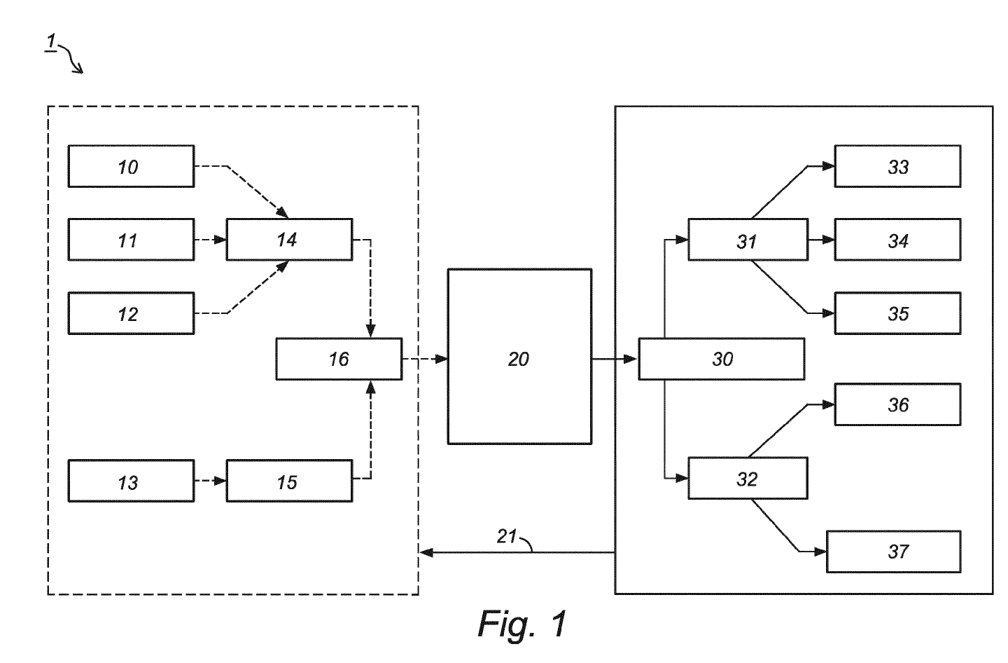

FIG. 1 shows a schematic representation of the method and associated system for storing a graphical representation according to the invention,

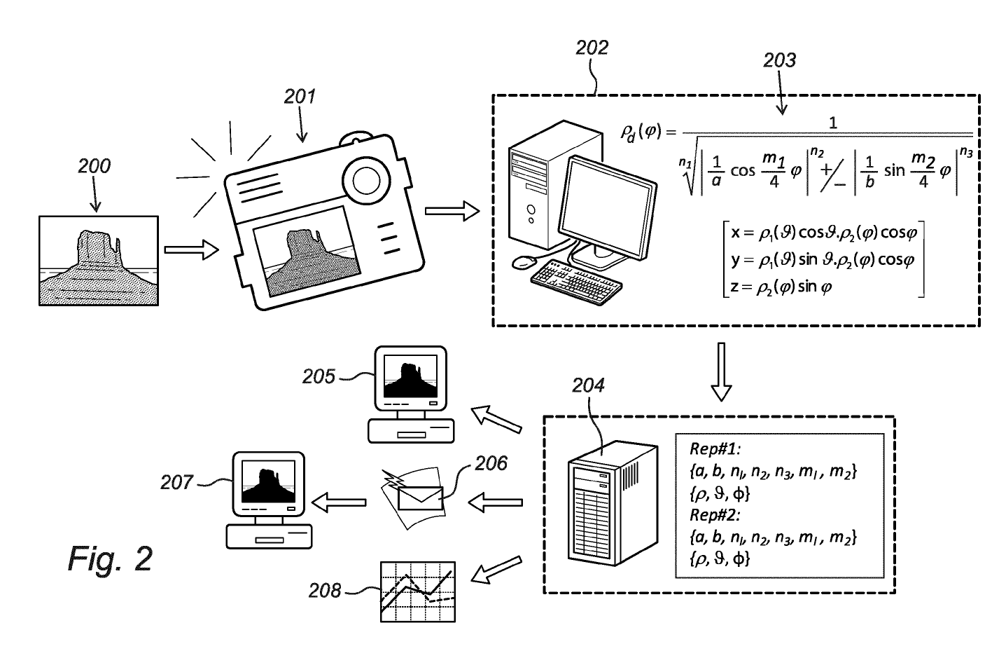

FIG. 2 shows a different schematic representation of the method according to the invention,

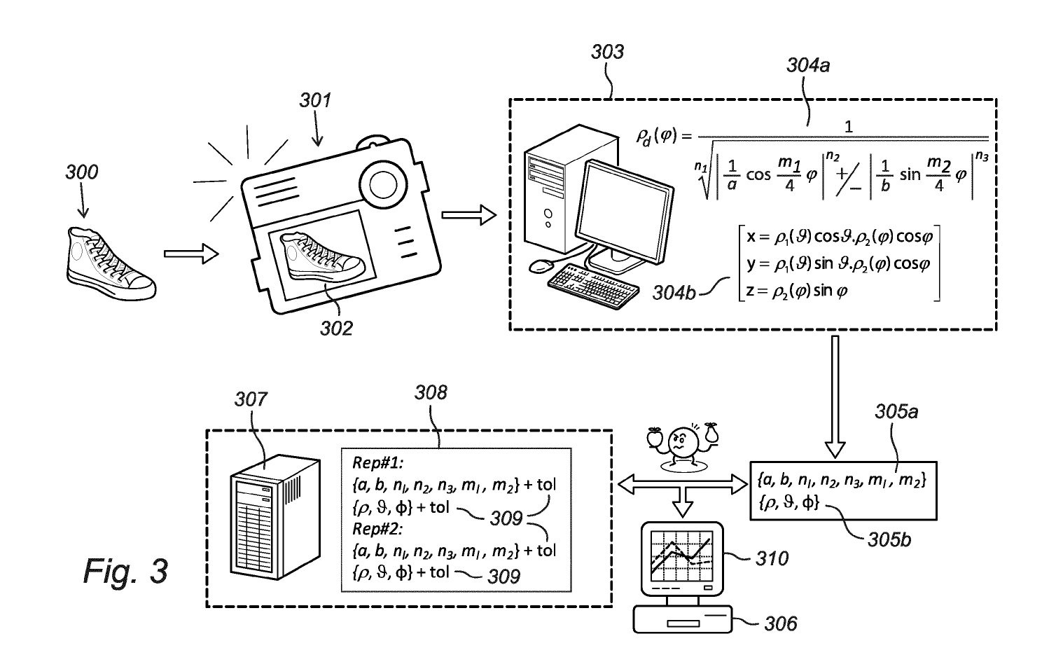

FIG. 3 shows a schematic representation of a method for comparing graphical representations according to the invention,

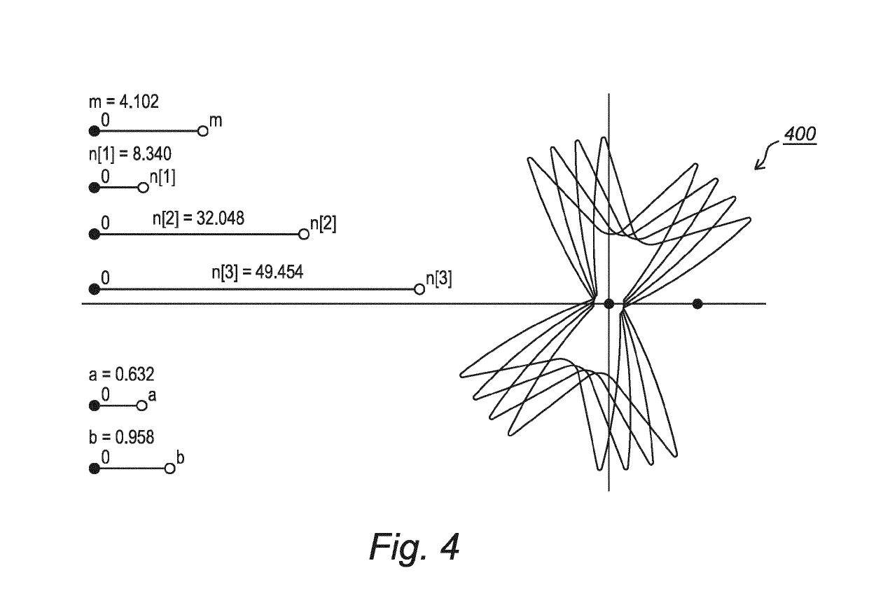

FIG. 4 shows a view of a two-dimensional graphical representation and associated parameter values,

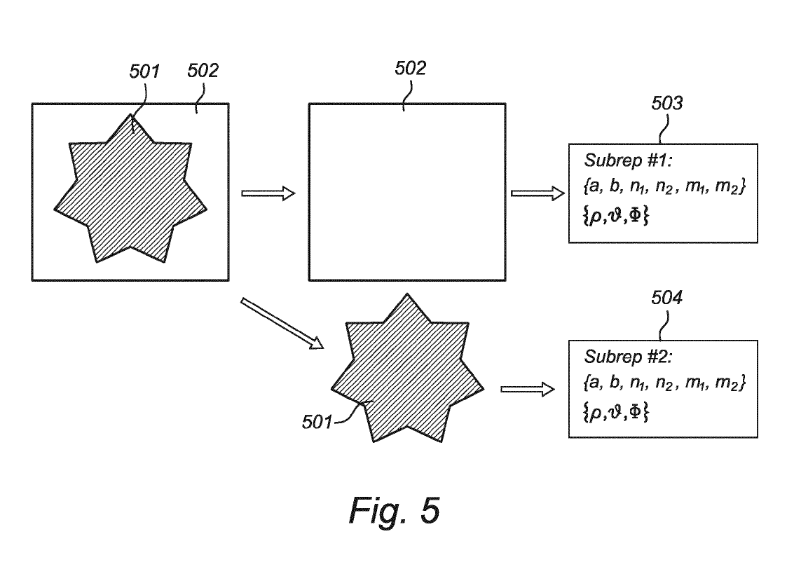

FIG. 5 shows a view of a two-dimensional graphical representation and division hereof into sub-representations,

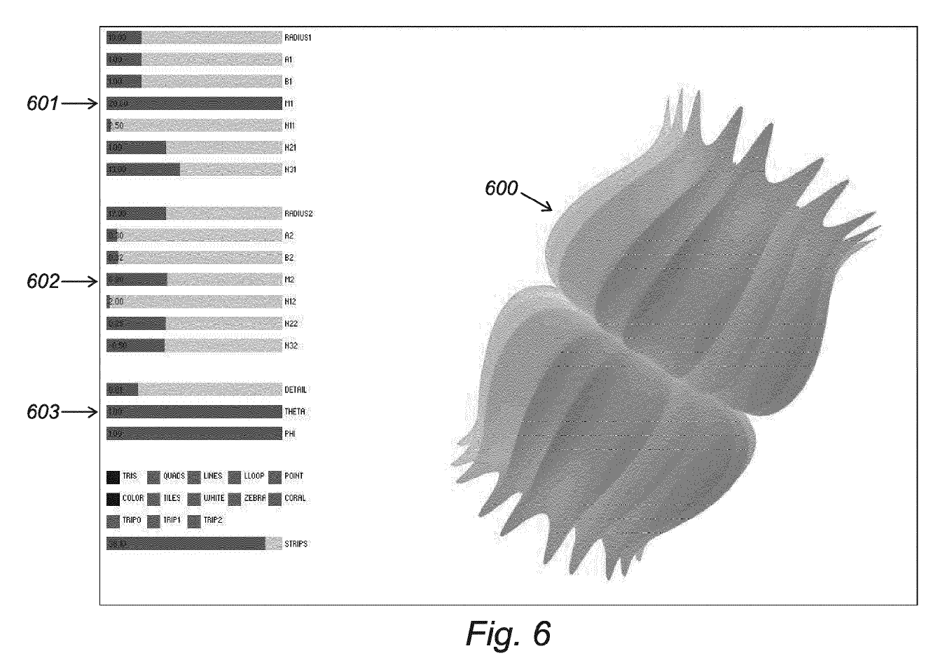

FIG. 6 shows a view of a three-dimensional graphical representation and associated parameter values,

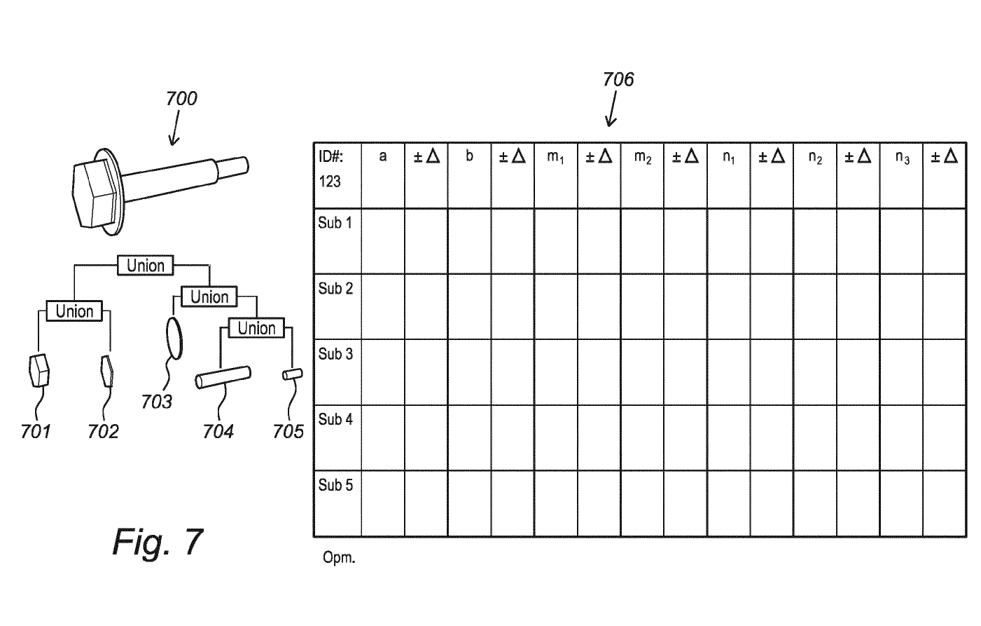

FIG. 7 shows a view of a graphical representation of a bolt and division hereof into basic shapes,

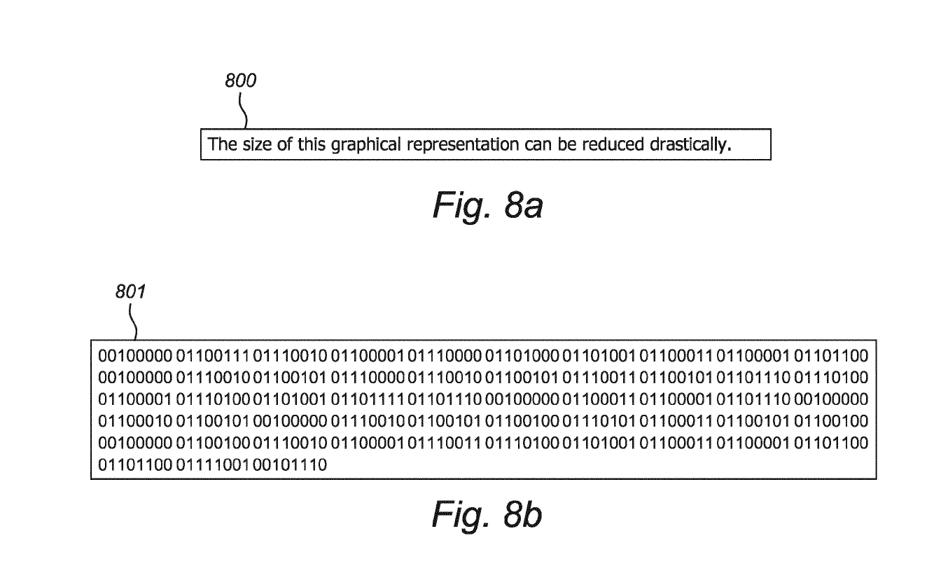

FIG. 8a shows a view of textual information which can be converted into parameter set values by applying the method according to the invention,

FIG. 8b shows a view of binary information which can be converted into parameter set values by applying the method according to the invention,

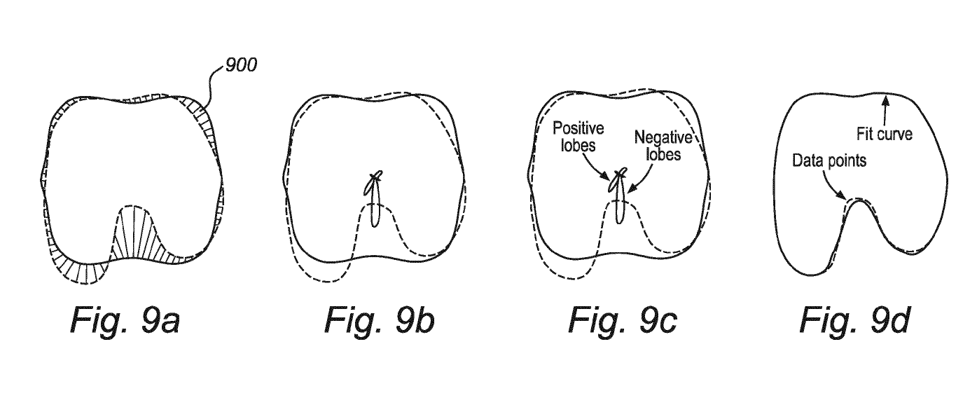

FIGS. 9a-9d show successive steps for having an original graphical representation framed by means of a curve which can be determined by applying the method according to the invention,

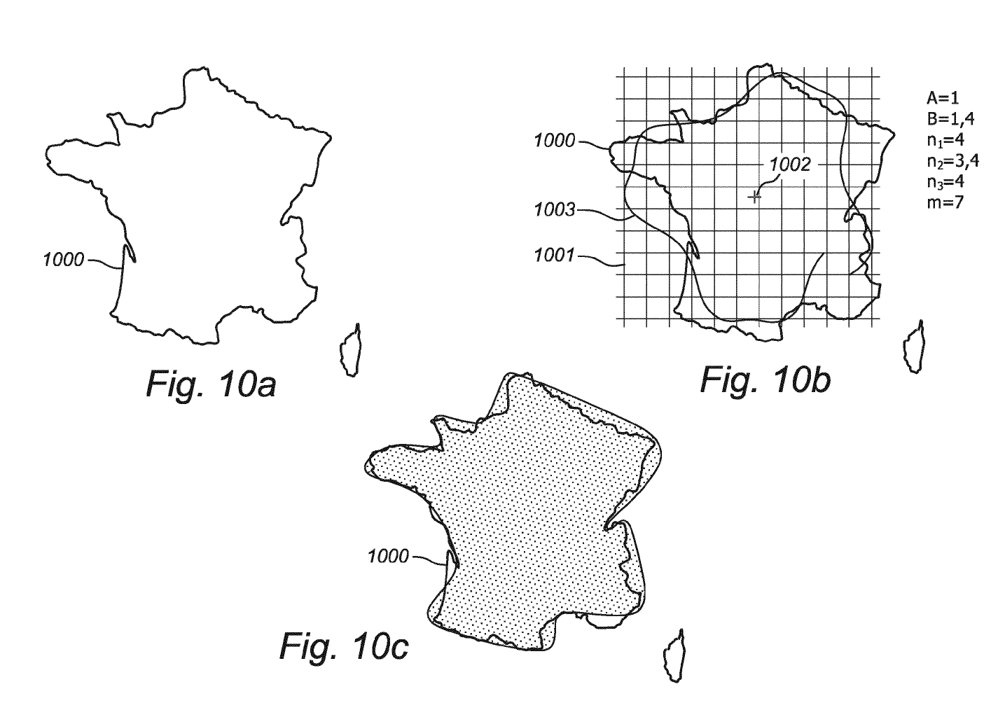

FIGS. 10a-10d show successive steps for having a different original graphical representation framed by means of a curve which can be determined by applying the method according to the invention,

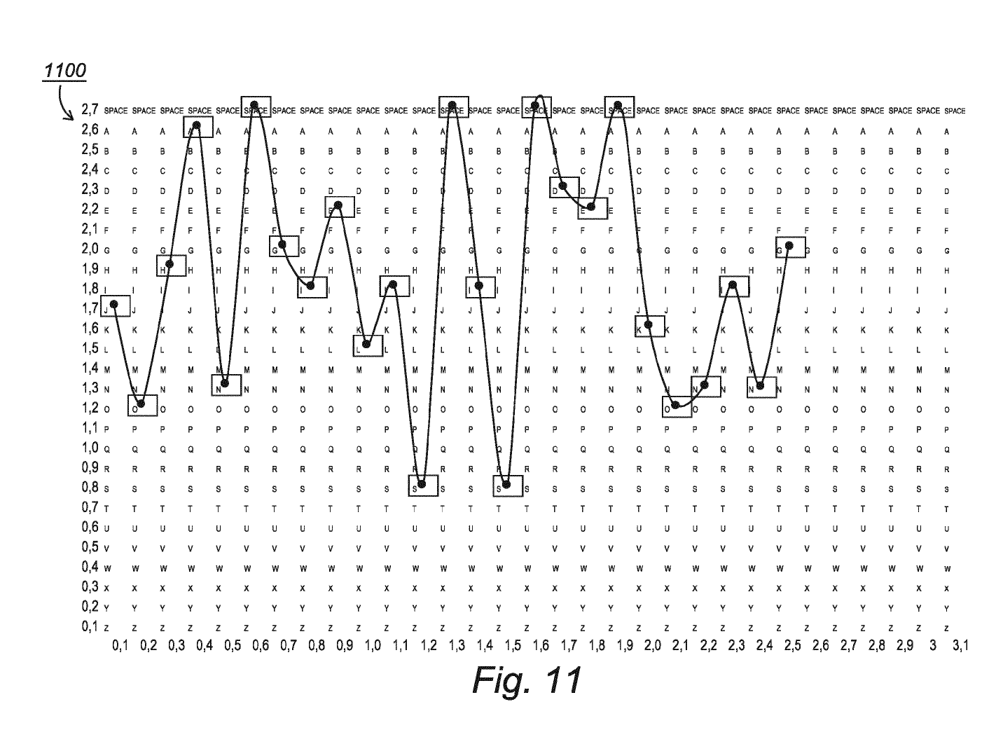

FIG. 11 shows a view of a geometric space in which textual information can be projected for use in the method according to the invention,

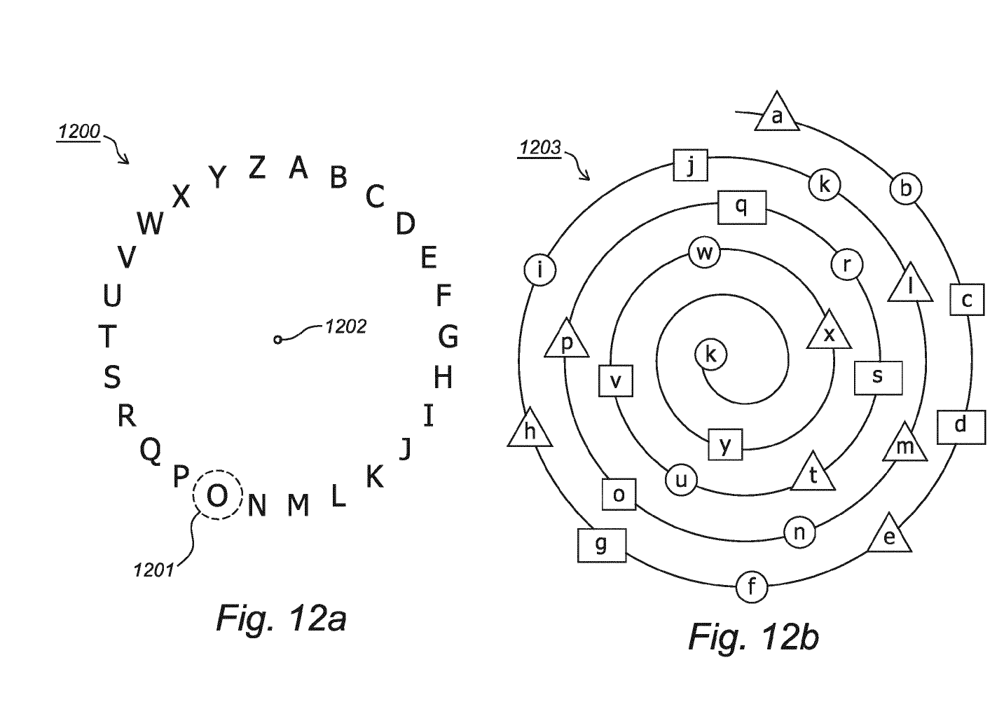

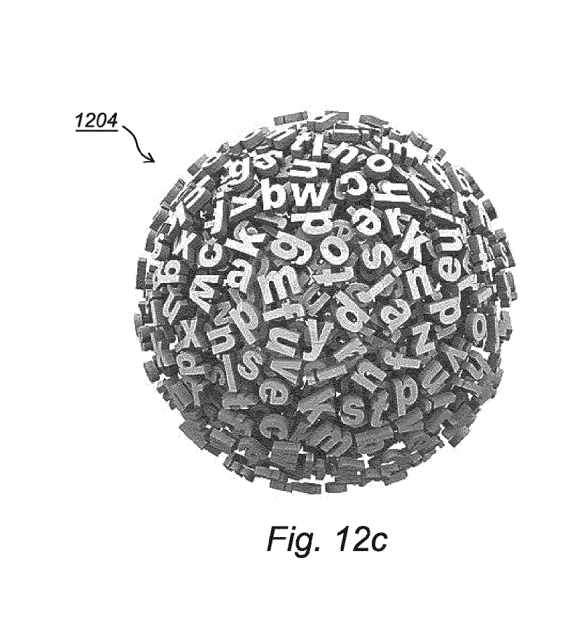

FIGS. 12a-12c show views of alternative geometric spaces in which, in particular, textual information can be projected for use in the method according to the invention,

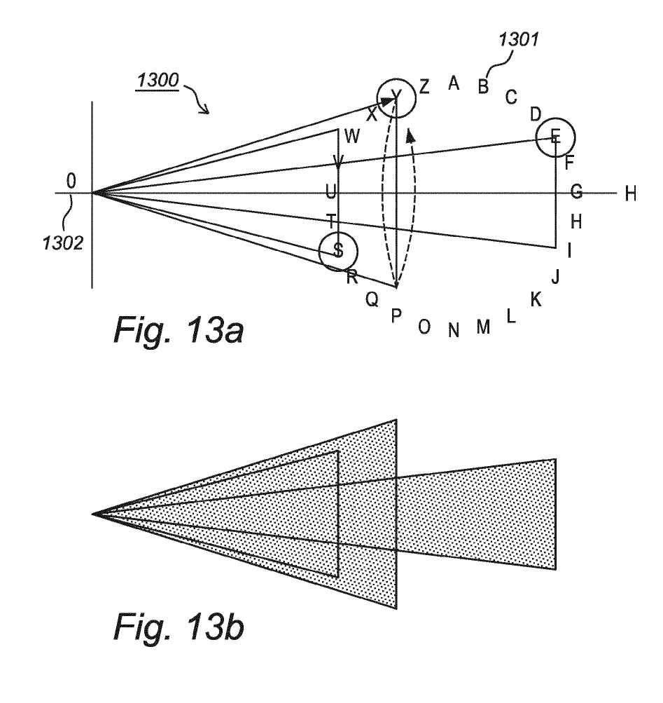

FIG. 13a shows a view of the application of the geometric space for converting textual information into coordinates, and

FIG. 13b shows a side view of a graphical representation of the textual information concerned, obtained on the basis of the coordinates shown in FIG. 13a.

FIG. 1 shows a schematic representation of the method and associated system 1 for storing information, in particular a graphical representation, according to the invention. For this purpose, the system 1 comprises a digital input 16 to enable the digital input of a graphical representation. This graphical representation may already be available in digital format 13, and may, for example, be stored in permanent form on a hard disk 15. It is also conceivable for the graphical representation to be stored in volatile form 14 and to be supplied to the input 16 via a RAM memory 10, via generated data 12, for example random numbers, GPS data, power consumption, e-mail traffic, etc. Similarly, the data stored in volatile form can be obtained via a scanning device 11, in particular a photo camera, or via sensors (also denoted as 11) such as seismic sensors, gyroscopes, light sensors, photo chips, microphones, ultrasound sensors, lasers, radar, pressure sensors. A computer 20 comprises one or more processing units (processors). The computer 20 is programmed with at least one first formula:

$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - {\vert \frac{1}{B} sin \frac{{m}_{2} ϑ}{4} \vert}^{{n}_{3}} ] \text{?}$$

$$\text{?} \text{indicates text missing or illegible when filed}$$

where:
   A, B, n₁∈ [symbol] ₀
   m₁, m₂, n₂, n₃∈ [symbol]
   [symbol] ∈[0, k2π], where k∈ [symbol]
wherein a first set of parameters is formed by A, B, m₁, m₂, n₁, n₂, n₃, and
wherein a second set of parameters is formed by [symbol] and k.
and wherein the computer is preferably also programmed with a second formula:

$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$

said second formula being a summation of a plurality of first formulae, wherein the second computer is also configured to analyse the at least one set of coordinates determined by the first computer in order to determine a generalised comparison for the information, wherein the values for the first set of parameters, and preferably also the values for the second set of parameters, are determined.

The computer 20 is possibly programmed, additionally or alternatively, with at least one formula:

$${ρ}_{d} ( ϕ ) = \frac{1}{\text{?} \sqrt{{\vert \frac{1}{a} cos \frac{{m}_{1}}{4} ϕ \vert}^{{n}_{2}} + / - {\vert \frac{1}{b} cos \frac{{m}_{2}}{4} ϕ \vert}^{{n}_{2}}}}$$

$$\text{?} \text{indicates text missing or illegible when filed}$$

wherein an associated set of parameters is defined as:
a, b∈ [symbol]
m₁, m₂, n₁, n₂, n₃∈ [symbol]
a, b, n1≠0
ρ_{d}(φ) a radius in the XY plane; and
φ∈[0, 2kπ), where k∈ [symbol] and relates to an angular coordinate;
   preferably also with a following formula:

$$[ \begin{matrix}x = {ρ}_{1} ( ϑ ) cos ϑ \cdot {ρ}_{2} ( ϕ ) cos ϕ \\ y = {ρ}_{1} ( ϑ ) sin ϑ \cdot {ρ}_{2} ( ϕ ) cos ϕ \\ z = {ρ}_{2} ( ϕ ) sin ϕ\end{matrix} ]$$

wherein a following set of parameters is defined as:
   ρ as the function according to the first formula
   [symbol] ∈[0, 2kπ], where k∈ [symbol] ; and
   φ∈[−½kπ, ½kπ], where k∈ [symbol] .

The two last-named formulae form the conventional superformulae, also referred to as the Gielis formulae. This example embodiment is furthermore based on the first-named (first and second) formulae. The processors of the computer 20 are configured to enable calculation with said formulae on the basis of the graphical representation entered via the input 16, and to convert the graphical representation into at least one first set of parameters and/or at least one second set of parameters, referred to as the output 30. The graphical representation is thereby converted into a limited series of numbers, and can thereby be drastically reduced in size. During the analysis and conversion of the graphical representation, further analyses can be carried out, including analyses of these data, for example for calculations of distances between circumferential points which coincide with the graphical representation, semantic distances, aerodynamic properties, statistical data, degree of similarity, configuration of n-dimensional spaces, etc. The data obtained can optionally be fed back from the output 30 to the input 16 for a possible re-analysis and/or subsequent analysis. The sets of parameters obtained via the output 30 can be stored permanently 32 in a digital information collection 36, also referred to as a digital data collection or database. It is also conceivable for these sets of parameters to be collected 37 in a similar manner, for example through the physical printing of the obtained sets of parameters on a data medium, such as a sheet of paper or plastic sheet or plate. It is also conceivable to store the sets of parameters obtained by means of calculation in volatile form 31 and, for example, to play parameter-related information in audible form 33, in visual form 34, or in kinetic form 35. After the playing of said parameter-related information, this volatile information 31 will usually be deleted (from a memory of a computer).

FIG. 2 shows a different schematic representation of the method according to the invention. In this example embodiment, a physical landscape 200 is regarded as a graphical representation (information), the shape of which is stored digitally. To do this, one or more digital photos 201 are first taken of the landscape 200. This usually involves a plurality of photos, possibly stereo photos, in order to be able to map the landscape as accurately as possible in three-dimensional form. These one or more photos 201 are forwarded to a computer 202 which is programmed to be able to calculate with the superformulae 203 specified in Claim 1, as a result of which each graphical representation (Rep#1, Rep#2, etc.) can be converted into one or more sets of parameters. The calculated sets of parameters are stored in a database 204. Sets of parameters associated with one another or related to one another are preferably stored in the database 204 with a cross-reference to one another. Additional information relating to the landscape, coordinates, date, time, etc. can optionally be stored here in the database 204. The data stored in the database 204 can be applied in various ways. Firstly, it is possible to create the graphical representation once more on the basis of the sets of parameters and display it on a monitor 205, usually by means of said computer or with a different computer which is configured to be able to calculate with the superformulae. It is also possible to transmit the sets of parameters via a network connection 206, locally or via the Internet, to a different computer 207, such as a PC, MAC, Smartphone, Tablet, etc. It is also conceivable to analyse the stored data by means of analysis software 208.

FIG. 3 shows a schematic representation of a method for comparing information, in particular graphical representations, according to the invention. In this embodiment, an (image of a) physical object, in this case a shoe 300, is regarded as a graphical representation which can be digitised by means of a photo camera 301 or other type of image scanner, whereafter the digitised image 302 is fed to a computer 303 configured to convert the image 302 by means of one or both shown superformulae 304a, 304b into one or more sets of parameters 305a, 305b. The one or more obtained sets of parameters 305a, 305b are compared by means of a computer 306, which may be the same computer as said computer 303, with sets of parameters 308 stored in a database 307. A tolerance (“tol”) 309 is applied to the sets of parameters stored in the database 308 in order to maintain some flexibility in the exact shape of the stored graphical representations, so that minor modification of the original graphical representations is also covered by the graphical representations stored in the database 306. The computer 306 compares the calculated set(s) of parameters 305a, 305b with the stored set of parameters 308 and, depending on the outcome of this comparative assessment, supplies information 310 to a user. In this way, it is possible quickly and effectively to establish whether a graphical representation bears a resemblance to or even matches already registered graphical representations. This makes it possible, for example, to identify counterfeit goods quickly and effectively. The applied tolerance values 310 can be entered manually, or in an automated manner. It is even conceivable to have the tolerance values determined on the basis of previously made case law relating to counterfeit goods, as a result of which an accurate indication can also be obtained relatively quickly and effectively of the infringement risks of the examined shoe 300 in relation to the—possibly protected—sets of parameters included in the database 306 and associated with different shoes.

FIG. 4 shows—by way of illustration—a view of a two-dimensional graphical representation of a complex star-shaped image 400 and associated parameter values. FIG. 5 shows a view of a two-dimensional graphical representation of a star 501 in a plane 502 and division hereof into sub-representations, in particular the star 501 and the plane 502. By transforming more complex (combined) shapes into simpler shapes (sub-representations) which can be expressed by means of the superformula(e), a combination (set) of sets of parameters 503, 504 can be obtained which jointly describe the graphical representation. The combination of sets of parameters 503, 504 already forms a data collection in the context of this patent specification. Information will also usually be stored here relating to how the basic shapes are positioned in relation to one another, for example by specifying original XY(Z) coordinates. FIG. 6 shows a view of a three-dimensional graphical representation 600 and associated parameter values 601, 602, 603, indicating that a plurality of sets of parameters, i.e. a plurality of values for the parameters A, B, m, n₁, n₂, n₃, and the parameters Θ and k play a part. With the storage of the graphical representation in parameter format, all parameter values will be stored.

FIG. 7 shows a view of a graphical representation of a bolt 700 and division hereof into basic shapes 701-705, wherein each basic shape 701-705 forms a sub-representation (“Sub1-Sub5”) which can be expressed by means of the superformula(e) in one or more sets of parameters. Known CSG techniques (Constructive Solid Geometry techniques) are generally used here. The set of parameters {a, b, m₁, m₂, n₁, n₂, n₃} obtained for each basic shape 701-705 will be stored in a database, of which only one record 706 is shown, wherein for each parameter—in this example embodiment—a permitted standard deviation (tolerance±Δ) is also recorded. Comments (“comm.”) can also be added to the record 706.

FIG. 8a shows a view of textual information 800 which, as a graphical representation, can be converted into parameter set values by applying the method according to the invention. The same applies to the binary information 801 as shown in FIG. 8b, whereby the quantity of information, usually expressed in bytes, which is stored in a computer memory can be drastically reduced, thereby considerably increasing the processing speed of computers and substantially reducing a network load.

FIGS. 9a-9d show successive steps for having an original graphical representation framed by means of a (Gielis) curve which can be determined by applying the method according to the invention. FIG. 9a shows a prostate 900, wherein—from left to right—the shape of the prostate 900 is estimated (FIG. 9a), wherein differences between a first curve and the actual shape of the prostate 900 are estimated, whereafter the shape is divided into sub-shapes (basic shapes), whereafter a second, more definitive curve can be calculated, the shape of which substantially matches the actual shape of the prostate (FIGS. 9b-9d).

In FIGS. 10a-10c, the shape of a top view of France is mapped in the same way, wherein the shape of France can still be particularly closely approximated through iteration and application of a plurality of (Gielis) curves, and wherein the parameters associated with the final curve(s) are stored in a computer memory. For this purpose, the original shape 1000 is projected in a two-dimensional geometric space 1001 with a centre 1002 (see FIG. 10b), whereafter a curve matching the original shape as closely as possible can be found by means of a computer programmed with at least the first formula. FIG. 10b shows in the first instance a less closely matching first curve 1003, with associated parameters, said curve 1003 being improved during the iteration process (see FIG. 10c) to produce a final ideal curve. From this final ideal curve, at least a part of the parameters of the first formula and/or the second formula is stored in a computer memory. Furthermore, this iteration process does not necessarily have to be represented graphically. This iteration process could also be carried out as a background process.

FIG. 11 shows a simple alphabetical matrix 1100, which can be regarded as a geometric space or as a Cartesian coordinate system, said matrix 1100 being formed by discrete coordinates (information points). The matrix 1100 consists of 31 columns and 27 rows, wherein each column is made up of one punctuation mark (SPACE) and the letters of the alphabet. The horizontal position and vertical position of the coordinates are shown respectively on the X-axis and the Y-axis. This space is suitable for projecting textual information. By successively projecting the letters and spaces in a sentence in the matrix 1100, a dot pattern is created through which an ideal curve according to the first formula and possibly the second formula can be drawn. The parameters associated with this ideal curve can then be stored in a computer memory.

The number of parameters in this example embodiment will be expected to be between 5 and 7 parameters (A, B, n1, n2, n3, and possibly m (m1, m2), while the number of original characters in this embodiment is 25, which, in the case of a short sentence of this type, already results in a substantial reduction in the volume of the information. In the case of increasing textual information, this reduction will be able to increase further, in a significant manner, partly due to the fact that the number of parameters will remain particularly limited. In more detail, it is noted that a key is determined for the information to be coded using the matrix 1100. The key consists of a distribution of discrete information points. An information point is determined in the Cartesian coordinate system by x, y, and r. r is the radius of a circle around the (x,y) coordinate. If the information point thus defined is touched by a line, the information point is regarded as triggered. If it is not touched by a line, it is regarded as not triggered. The x-axis represents the x-coordinate of a discrete information point. In this example, a nominal scale division is located on the x-axis to represent the sequence from left to right of the information points to be touched, to be transformed into polar coordinates from 0 to x*PI degrees. The y-coordinate of a discrete information point is represented on the Y-axis. An information point has a. In this example, an information point corresponds to an ASCII character. This scale can be divided in a manner which optimally suits the piece of information to be coded, i.e., for example, logarithmically also. In order to then code text, a series of information points is designated in the sequence of the characters of a text. This sequence of information points represents a pattern. These information points are then connected by means of a curve in such a way that only the intended information points are touched. The curve in FIG. 11 is usually optimally described by the superformula, more complex forms by the combination with R-functions. This system, shown here in two dimensions, is also used in 3-dimensional and multi-dimensional coding systems. It is obviously not limited to text characters alone, but is applicable to any given information for which a key can be made by creating information points.

FIG. 12a shows a view of an alternative geometric space 1200 in which textual information can be projected. Instead of a matrix, the basic elements 1201 (letters) of textual information are arranged here in alphabetical order around a centre 1202. By projecting the information in the space 1200, the textual information can be transformed by means of vectors, curves and/or bodies of revolution into one or more sets of parameters which can be stored in a computer memory. An alternative space 1203 is shown in FIG. 12b, wherein the basic elements are arranged in a spiral shape. The operation of a space of this type is identical to the geometric space 1200 according to FIG. 12a. It is also conceivable to apply more complex geometric spaces, as shown, for example, in FIG. 12c, wherein the geometric space 1204 has an onion structure and is made up of layers of basic characters, wherein the distance of each layer in relation to a centre of the space 1204 differs. The type of each layer may be identical here, but may also vary. It is conceivable, for example, for each layer to consist of the same series of ordered basic characters (for example letters and punctuation marks), but it is also conceivable for one or more layers to be intended for the recording of different types of information, such as fonts, font colours, font sizes, etc.

FIG. 13a shows a simple circular geometric space 1300 provided with letters 1301 and with a centre 1302 outside the circle formed by the letters, in which space 1300 textual information, in particular words, can be projected. In this example embodiment, the word “YES” is taken as the starting point. By projecting the letters in the word “YES” in the predefined space 1300, coordinates are produced in the space 1300 concerned. A vector running from the centre to a coordinate can then be rotated around a horizontal axis H, thereby producing a conical shape (see FIG. 13b). This can be done with each coordinate, whereby three conical shapes are formed which can be expressed as a set or sets of parameters and stored. It is also conceivable for a vector to be taken during the revolution to a following coordinate, whereby a spiral-shaped (or otherwise complex) three-dimensional shape is created which can also be expressed in one or more sets of parameters. This more complex shape is not shown in FIG. 13.

It should be clear that the invention is not limited to the example embodiments illustrated and described here, but that countless variants, which will be obvious to the person skilled in the art in this field, are possible within the framework of the accompanying claims.

1. A method for analysing information and storing a representation related to the information in a computer memory, comprising the steps:
A) providing the information to be analysed in digital format,
B) converting the digital information into at least one set of coordinates relating to at least one preselected coordinate system, wherein the preselection of the coordinate system is carried out by a computer, wherein the computer either creates at least one random coordinate system and/or selects said at least one coordinate system from a set of predefined coordinate systems,
C) programming a computer with at least one first formula:
$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - {\vert \frac{1}{B} sin \frac{{m}_{2} ϑ}{4} \vert}^{{n}_{3}} ] \text{?}$$
$$\text{?} \text{indicates text missing or illegible when filed}$$
where:
A, B, n₁∈ [symbol] ₀
m₁, m₂, n₂, n₃∈ [symbol] [symbol]
∈[0, k2π], where k∈ [symbol]
wherein a first set of parameters is formed by the parameters A, B, m₁, m₂, n₁, n₂, and/or n₃, and wherein a second set of parameters is formed by [symbol] and k.
and wherein the computer is preferably also programmed with a second formula:
$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$
said second formula being a summation of a plurality of first formulae;
D) analysing the digital information in the computer on the basis of the at least one set of coordinates in order to determine at least one generalised comparison for the information, wherein the values for the first set of parameters, and preferably also the values for the second set of parameters, are determined; and
E) storing in at least one computer memory, preferably a digital database, at least one cross-reference between information relating to the at least one preselected coordinate system used during step B), and the first set of parameters and/or second set of parameters determined during step D).

2. The method according to claim 1, wherein during step B) or step D) at least one coordinate reconstruction definition is defined.

3. The method according to claim 2, wherein said at least one coordinate reconstruction definition is stored in a computer memory, preferably a database, during step E), as cross-reference to the at least one preselected coordinate system used during step B), and the first set of parameters and/or second set of parameters determined during step D).

4. The method according to claim 2, wherein each coordinate of each coordinate system used during step B) is assigned to an outlined coordinate space, wherein a coordinate reconstruction definition is related to said outlined coordinate space.

5. The method according to claim 1, wherein during step D) and following the determination of the first set of parameters, the parameter values of said first said are minimized using a statistical optimal technique, preferably by applying the iterative Levenberg-Marquardt algorithm.

6. The method according to claim 1, wherein the information is projected during step B) in at least one predefined n-dimensional geometric space, as a result of which the at least one set of coordinates is formed.

7. The method according to claim 6, wherein the geometric space is provided with basic characters which are distributed at predefined locations over the geometric space.

8. The method according to claim 6, wherein each geometric space is provided with at least one centre.

9. The method according to claim 8, wherein each set of coordinates determined during step B) is relative in relation to the centre of the geometric space concerned, and wherein during step E), preferably information relating to the centre of the geometric space is stored in the computer memory.

10. The method according to claim 1, wherein at least one body of revolution is determined during step D) on the basis of the set of coordinates, said body of revolution being related to at least one set of parameters.

11. The method according to claim 1, wherein the digital information is converted during step B) into a plurality of sets of coordinates.

12. The method according to claim 11, wherein the information is projected during step B) in a plurality of predefined n-dimensional geometric spaces, as a result of which the plurality of sets of coordinates are formed.

13. The method according to claim 12, wherein at least one n-dimensional geometric space comprises at least one other n-dimensional geometric space.

14. The method according to claim 1, wherein the at least one determined set of parameters stored during step E) forms part of a data collection stored in the computer memory.

15. The method according to claim 14, wherein the method also comprises step F), comprising the allocation of an identification code to the representation, wherein the identification code and the related at least one set of parameters are stored in the data collection as a cross-reference during step E).

16. The method according to claim 14, wherein at least one digital photo is taken of the information during step A), wherein the at least one digital photo is stored in the data collection as a cross-reference to the related set of parameters during step E).

17. The method according to claim 14, wherein the method also comprises step G), comprising the allocation of user-defined information to the graphical representation, and the storage during step E) of the user-defined information as a cross-reference to the at least one set of parameters in the data collection.

18. The method according to claim 14, wherein the method comprises step H), comprising the determination of tolerance values for the at least one set of parameters determined during step D), and the storage during step E) of the determined tolerance values in the data collection as a cross-reference to the related set of parameters.

19. The method according to claim 14, wherein a plurality of sets of parameters are stored during step E).

20. The method according to claim 14, wherein the data collection is created during step E).

21. The method according to claim 14, wherein the data collection relates to a digital database.

22. The method according to claim 14, wherein the digital information is converted into a plurality of sets of coordinates during step B), wherein each set of coordinates is analysed in the computer during step D) in order to determine at least one generalised comparison for the set of coordinates, wherein the values for the first set of parameters, A, B, n₁, n₂, n₃, m₁ or m₂, and preferably also the values for the second set of parameters Θ and k, are determined, and wherein the first set of parameters and/or second set of parameters associated with each set of coordinates is/are stored in the data collection during step E).

23. The method according to claim 14, wherein the information relates to a dynamic pattern which is subjected to a time-dependent transformation.

24. The method according to claim 23, wherein a plurality of chronological digital images are generated in step A) from the dynamic pattern, said chronological images being individually converted into at least one set of coordinates during step B) and being analysed during step D), and wherein the sets of parameters obtained during step D) are stored in the data collection as a cross-reference to one another during step E).

25. The method according to claim 23, wherein the dynamic pattern relates to a video.

26. The method according to claim 1, wherein the information relates to at least a part of a physical object and/or image.

27. The method according to claim 1, wherein the at least a part of the information relates to textual information and/or a numerical representation.

28. The method according to claim 1, wherein the information relates to at least a part of a representation of a wave.

29. The method according to claim 1, wherein physical information is digitised during step A).

30. The method according to claim 1, wherein the method also comprises step I), comprising the transfer of the digital information to the computer before the digitised graphical representation is analysed during step D) by means of the computer.

31. The method according to claim 30, wherein step I) also comprises an authentication step wherein a user wishing to initiate a transfer is authenticated and the digital information is transferred to the computer only following authentication of the user.

32. The method according to claim 1, wherein the at least one set of parameters is stored during step E) in an internal memory of a computer.

33. The method according to claim 1, wherein the at least one set of parameters is stored during step E) in an external memory of a computer.

34. The method according to claim 1, wherein the data stored during step E) are stored in encrypted form in the computer memory.

35. The method according to claim 1, wherein the method also comprises step J), comprising the digital transmission of at least one set of parameters stored during step E) to a different location.

36. The method according to claim 1, wherein a graphical representation of the at least one set of parameters determined during step D) is physically printed during step E).

37. A method for comparing information, comprising the steps:
K) providing a data collection, in particular a digital database, in which first sets of parameters and/or second sets of parameters associated with information are stored according to the method according to claim 1,
L) providing the information to be compared in digital format,
M) converting the digital information to be compared into at least one set of coordinates,
N) programming a computer with at least one first formula:
$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + {\vert \frac{1}{B} sin \frac{{m}_{2} ϑ}{4} \vert}^{{n}_{3}} ] \text{?}$$
$$\text{?} \text{indicates text missing or illegible when filed}$$
where:
A, B, n₁∈ [symbol] ₀
m₁, m₂, n₂, n₃∈ [symbol] [symbol]
∈[0, k2π], where k∈ [symbol]
wherein a first set of parameters is formed by A, B, m₁, m₂, n₁, n₂, n₃, and wherein a second set of parameters is formed by [symbol] and k.
and wherein the computer is preferably also programmed with a second formula:
$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$
said second formula being a summation of a plurality of first formulae;
O) analysing the at least one set of coordinates obtained during step M) in the computer in order to determine a generalised comparison for the information, wherein the values for the first set of parameters, and preferably also the values for the second set of parameters, are determined; and
P) comparing the first set of parameters and/or second set of parameters associated with the information to be compared with the first sets of parameters and/or second sets of parameters as stored in the data collection, in particular the digital database.

38. The method according to claim 37, wherein the method comprises step Q), comprising the presentation of a result of the comparison subsequent to the comparison of the first set of parameters and/or second set of parameters associated with the information to be compared with the first sets of parameters and/or second sets of parameters as stored in the data collection, in particular the digital database, according to step P).

39. The method according to claim 37, wherein step H) is also applied during step K), comprising the determination of tolerance values for the at least one set of parameters determined during step D), said determined tolerance values being stored in the data collection as a cross-reference to the related set of parameters, and wherein, during step P), the first set of parameters and/or second set of parameters of the graphical representation to be compared are compared with the range which is defined by the tolerance values stored in the data collection.

40. A method for regenerating information which is stored as a representation in a computer memory after applying the method according to claim 1, comprising the steps:
R) reading at least one computer memory, preferably a digital database, wherein at least one cross-reference is stored between the at least one preselected coordinate system used during step B), and the first set of parameters and/or second set of parameters determined during step D),
S) calculating at least one set of coordinates by entering the parameters read during step R) into a computer programmed with at least one first formula:
$$ρ ( ϑ \text{:} f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + / - {\vert \frac{1}{B} sin \frac{{m}_{2} ϑ}{4} \vert}^{{n}_{3}} ] \text{?}$$
$$\text{?} \text{indicates text missing or illegible when filed}$$
where:
A, B, n₁∈ [symbol] ₀
m₁, m₂, n₂, n₃∈ [symbol] [symbol]
∈[0, k2π], where k∈ [symbol]
wherein a first set of parameters is formed by the parameters A, B, m₁, m₂, n₁, n₂, and/or n₃, and wherein a second set of parameters is formed by [symbol] and k.
and wherein the computer is preferably also programmed with a second
$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$
said second formula being a summation of a plurality of first formulae; and
T) converting the calculated coordinates into the original digital information.

41. The method according to claim 40, wherein during step S) at least one coordinate reconstruction definition is used.

42. The method according to claim 41, wherein at least one coordinate reconstruction definition is read from the computer memory during step R).

43. The method according to claim 42, wherein said at least one coordinate reconstruction definition comprises a definition of an outlined coordinate space of the coordinates of the coordinate system.

44. A system for analysing information and storing a representation related to the information in a computer memory, in particular by applying the method according to claim 1, comprising:
at least one first computer configured to convert digital information into at least one set of coordinates;
at least one second computer programmed with at least one first formula:
$$ρ ( ϑ ; f ( ϑ ) , A , B , {m}_{1 , 2} , {n}_{1} , {n}_{2} , {n}_{3} ) = f ( ϑ ) [ {\vert \frac{1}{A} cos \frac{{m}_{1} ϑ}{4} \vert}^{{n}_{2}} + {\vert \frac{1}{B} sin \frac{{m}_{2} ϑ}{4} \vert}^{{n}_{3}} ] \text{?} \text{?} \text{?} \text{indicates text missing or illegible when filed}$$
where:
A, B, n₁∈ [symbol] ₀
m₁, m₂, n₂, n₃∈ [symbol] [symbol]
∈[0, k2π], where k∈ [symbol]
wherein a first set of parameters is formed by A, B, m₁, m₂, n₁, n₂, n₃, and wherein a second set of parameters is formed by [symbol] and k.
and wherein the computer is preferably also programmed with a second formula:
$$P ( ϑ ) = {\sum }_{j = 1}^{k} {ρ}_{i} ( ϑ \text{:} {f}_{j} ( ϑ ) , {A}_{j} , {B}_{j} , {m}_{1 j , 2 j} , {n}_{1 j} , {n}_{2 j} , {n}_{3 j} )$$
said second formula being a summation of a plurality of first formulae, wherein the second computer is also configured to analyse the at least one set of coordinates, related to at least one preselected coordinate system, determined by the first computer in order to determine a generalised comparison for the information, wherein the values for the first set of parameters, and preferably also the values for the second set of parameters, are determined; and
at least one computer memory for storing the first set of parameters and/or second set of parameters determined by means of the second computer, and in particular at least one cross-reference between information relating to the at least one preselected coordinate system.

45. The system according to claim 44, wherein the first computer and the second computer are formed here by the same computer.

46. The system according to claim 44, wherein at least one computer memory forms part of the second computer.

47. The system according to claim 44, wherein the first computer is programmed to project the information in a predefined n-dimensional geometric space, as a result of which at least one set of coordinates is formed.
